(19) United States
(12) Patent Application Publication
(10) Pub. No.: US 2024/0168164 A1
(43) Pub. Date: May 23, 2024

(54) OPTICAL DUAL WAVELENGTH LASER SPEED DETECTION SYSTEM

(71) Applicant: The Boeing Company, Chicago, IL (US)

(72) Inventors: Nathan D. Hiller, Irvine, CA (US); Robert M. Dowgwillo, St. Louis, MO (US); Ishaan Bakhle, Lynnwood, WA (US)

(21) Appl. No.: 18/057,609

(22) Filed: Nov. 21, 2022

(51) Int. Cl. G01S 17/58; G01S 7/48; G01S 7/481; G01S 7/4913

(52) U.S. Cl. CPC G01S 17/58; G01S 7/4804; G01S 7/4808; G01S 7/4811; G01S 7/4913

(57) ABSTRACT

A method for detecting a speed of an aircraft. A first backscatter light generated in response to emitting a first laser beam having a first wavelength is received. A first beat frequency for a first interfered light generated by interfering the first backscatter light and a first reference light is measured. A second backscatter light generated in response to emitting a second laser beam having a second wavelength is received. A second beat frequency for a second interfered light generated by interfering the second backscatter light with a second reference light derived is measured. The speed of the aircraft is determined using the first beat frequency in response a power of the first backscatter light being greater than a threshold and using the second beat frequency is determined in response to the power of the first backscatter light not being greater than the threshold.

### BACKGROUND INFORMATION

### 1. Field

The present disclosure relates generally to sensors and in particular, to a method, apparatus, and system for detecting a speed of a moving vehicle.

### 2. Background

A sensor such as a pitot tube is used to detect the speed of an aircraft. However, this type of sensor protrudes from the surface of aircraft to place the pitot tube into the airflow. This protrusion makes this type of sensor susceptible to environmental conditions. For example, unintended impacts, such as bird or insect strikes, can occur on a pitot tube. Other environmental issues include ice formation on the pitot tube.

Another type of sensor used for detecting speed is a light detection and ranging (LIDAR) sensor. With a LI DAR sensor, a laser beam is transmitted into the air and backscatter light generated in response to the laser beam is detected. The speed of the aircraft can be determined by comparing the frequency of the laser beam to the frequency in the backscatter. This shift in frequency can be used to calculate the speed of the aircraft.

### SUMMARY

An embodiment of the present disclosure provides a method for detecting a speed of an aircraft. A first backscatter light generated in response to emitting a first laser beam into an atmosphere from the aircraft is received. The first laser beam has a first wavelength. A first beat frequency for a first interfered light generated by interfering the first backscatter light and a first reference light derived from the first laser beam is measured. A second backscatter light generated in response to emitting a second laser beam into the atmosphere from the aircraft is received. The second laser beam has a second wavelength. A second beat frequency for a second interfered light generated by interfering the second backscatter light with a second reference light derived from the second laser beam is measured. The speed of the aircraft is determined using the first beat frequency in response a first power of the first backscatter light being greater than a threshold. The speed of the aircraft using the second beat frequency is determined in response to the first power of the first backscatter light not being greater than the threshold.

Another embodiment of the present disclosure provides a method for a speed of an aircraft. A first laser beam having a first wavelength is emitted. A second laser beam having a second wavelength is emitted. A first backscatter light generated in response to emitting the first laser beam into an atmosphere from the aircraft is received. A first beat frequency for a first interfered light generated from interfering the first backscatter light with a first reference light derived from the first laser beam is measured. A second backscatter light generated in response to emitting the second laser beam into the atmosphere from the aircraft is received. A second beat frequency for a second interfered light generated from interfering the second backscatter light with a second reference light derived from the second laser beam is measured. The speed of the aircraft is determined using the first beat frequency and the second beat frequency.

Yet another embodiment of the present disclosure provides an aircraft speed detection system for an aircraft. The aircraft speed detection system comprises an interference system, a detection system, and a speed analyzer. The interference system is configured to interfere a first backscatter light with a first reference light to form a first interfered light having a first beat frequency in response to receiving the first backscatter light. The first backscatter light is generated in response to emitting a first laser beam having a first wavelength and wherein the first reference light is derived from the first laser beam. The interference system is configured to interfere a second backscatter light with a second reference light to form a second interfered light having a second beat frequency in response to receiving the second backscatter light. The second backscatter light is generated in response to emitting a second laser beam having a second wavelength, the second reference light is derived from the second laser beam, and the first wavelength is shorter than the second wavelength. The detection system configured to measure the first beat frequency in the first interfered light and measure the second beat frequency in the second interfered light. The speed analyzer is configured to determine a speed for the aircraft using the first beat frequency in response to a first power of the first backscatter light being greater than a threshold. The speed analyzer is configured to determine the speed for the aircraft using the second beat frequency in response to the first power of the first backscatter light not being greater than the threshold.

In still another embodiment of the present disclosure, an aircraft speed detection system for an aircraft comprises a laser beam generator, a detection system, and a speed analyzer. The laser beam generator is configured to emit a first laser beam having a first wavelength and emit a second laser beam having a second wavelength. The first wavelength is shorter than the second wavelength. The detection system is configured to measure a first beat frequency for a first interfered light generated from interfering a first backscatter light detected in response to emitting the first laser beam and a first reference light derived from the first laser beam. The detection system is configured to measure a second beat frequency for a second interfered light generated from interfering a second backscatter light detected in response to emitting the second laser beam and a second reference light derived from the second laser beam. The speed analyzer is configured to determine a speed of the aircraft using the first beat frequency and the second beat frequency.

In yet another illustrative embodiment, an aircraft speed detection system for an aircraft comprises a first path, a second path, and a speed analyzer. The first path is configured to emit a first laser beam having a first wavelength, interfere a first backscatter light received in response to emitting the first laser beam with a first reference light derived from the first laser beam to form a first interfered light with a first beat frequency, and measure the first beat frequency for the first interfered light. The second path is configured to emit a second laser beam having a second wavelength, interfere a second backscatter light received in response to emitting the second laser beam with a second reference light derived from the second laser beam to form a second interfered light with a second beat frequency, and measure the second beat frequency for the first interfered light. The speed analyzer is in communication with the first path and the second path. the speed analyzer is configured to receive the first beat frequency from the first path, receive the second beat frequency from the second path and determine a speed of the aircraft using the first beat frequency and determine the speed of the aircraft using the second beat frequency in response to the first path being out of tolerance.

In another illustrative embodiment, an aircraft speed detection system for an aircraft comprises a tunable laser beam generator, an interference system, a detection system, and a speed analyzer. The tunable laser beam generator is configured to selectively emit the first laser beam and the second laser beam into an atmosphere from an aircraft. The interference system is configured to interfere a first backscatter light with a first reference light to form a first interfered light having a first beat frequency in response to receiving the first backscatter light. The first backscatter light is generated in response to emitting a first laser beam having a first wavelength and the first reference light is derived from the first laser beam. The interference system is configured to interfere a second backscatter light with a second reference light to form a second interfered light having a second beat frequency in response to receiving the second backscatter light. The second backscatter light is generated in response to emitting a second laser beam having a second wavelength, the second reference light is derived from the second laser beam, and first wavelength is shorter than the second wavelength. The detection system is configured to measure the first beat frequency in the first interfered light and measure the second beat frequency in the second interfered light. The speed analyzer is configured to determine a speed for the aircraft using the first beat frequency in response to a first power of the first backscatter light being greater than a threshold. The speed analyzer is configured to determine the speed for the aircraft using the second beat frequency in response to the first power of the first backscatter light not being greater than the threshold.

Another illustrative embodiment provides a method for detecting aerosols. A laser beam having a wavelength is emitted into an atmosphere. A backscatter light generated is received in response to emitting the laser beam into an atmosphere. A beat frequency is measured for an interfered light generated from interfering the backscatter light with a reference light derived from the laser beam. A set of characteristics is determined for the aerosols based on a power of the beat frequency.

Still another illustrative embodiment provides an aerosol detection system comprising a laser generation system, an interference system, a detector, and an aerosol analyzer. The laser generator system is configured to emit a laser beam into an atmosphere. The interference system is configured to interfere a backscatter light received in response to the laser beam with a reference light derived from the laser beam to form an interfered light having a beat frequency. The detector is configured to measure the beat frequency for the interfered light. The aerosol analyzer is configured to determine a set of characteristics for the aerosols based on a power of the beat frequency.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft is depicted in accordance with an illustrative embodiment;

FIG. 2 is an illustration of a block diagram of a speed detection environment in accordance with an illustrative embodiment;

FIG. 3 is an illustration of a block diagram of a laser generator in accordance with an illustrative embodiment;

FIG. 4 is an illustration of a speed detection system in accordance with an illustrative embodiment;

FIG. 5 is an illustration of light used to determine the speed of the vehicle in accordance with an illustrative embodiment;

FIG. 6 is a pictorial illustration of airflow over the surface of an aircraft in accordance with an illustrative embodiment;

FIG. 7 is an illustration of a graph of interference light in accordance with an illustrative embodiment;

FIG. 8 is an illustration of a graph of an interference light having a power that is greater than a threshold in accordance with an illustrative embodiment;

FIG. 9 is an illustration of a graph of an interference light having a power that is not greater than a threshold in accordance with an illustrative embodiment;

FIG. 10 is an illustration of a graph of interfered light from backscatter light generated from two laser beams having a power greater than a threshold in accordance with an illustrative embodiment;

FIG. 11 is an illustration of a speed detection system in accordance with an illustrative embodiment;

FIG. 12 is a flowchart of a process for detecting a speed of an aircraft in accordance with an illustrative embodiment;

FIG. 13 is an illustration of a flowchart of a process for indicating an error in accordance with an illustrative embodiment;

FIG. 14 is an illustration of a flowchart of a process for interfering backscatter light in accordance with an illustrative embodiment;

FIG. 15 is an illustration of a flowchart of a process for measuring power in accordance with an illustrative embodiment;

FIG. 16 is an illustration of a flowchart of process for measuring power in accordance with an illustrative embodiment;

FIG. 17 is an illustration of a flowchart of process for measuring power in accordance with an illustrative embodiment;

FIG. 18 is an illustration of a flowchart of a process for detecting a speed of an aircraft in accordance with an illustrative embodiment;

FIG. 19 is a flowchart of a process for determining the speed of an aircraft in accordance with an illustrative embodiment;

FIG. 20 is another flowchart of a process for determining the speed of an aircraft in accordance with an illustrative embodiment;

FIG. 21 is another flowchart of a process for determining the speed of an aircraft in accordance with an illustrative embodiment;

FIG. 22 is an illustration of a flowchart of a process for detecting aerosols in accordance with an illustrative embodiment;

FIG. 23 is an illustration of a flowchart of a process for determining a characteristic of aerosols in accordance with an illustrative embodiment;

FIG. 24 is an illustration of a flowchart of a process for determining a characteristic of aerosols in accordance with an illustrative embodiment;

FIG. 25 is an illustration of an aircraft manufacturing and service method in accordance with an illustrative embodiment; and

FIG. 26 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that under normal or optimal operating conditions, a laser beam such a light detection and ranging (LIDAR) beam is not distorted when emitted from the aircraft to detect speed of the aircraft. The laser beam scattering increases as the wavelength of the laser beam decreases. In other words, the amount of backscatter light occurring in response to emitting a laser beam increases as the wavelength of the laser beam decreases.

However, under non-ideal flight conditions such as those with turbulence, a laser beam such as a coherent LIDAR beam becomes distorted. This distortion reduces the accuracy or makes determining the speed of an aircraft impossible. The turbulence is turbulence in the airflow over the surface of aircraft. Turbulence can occur, for example, on a leading edge of a wing of an aircraft during different maneuvers or speeds. For example, when aircraft moves faster than the speed of sound, the amount of turbulence can make detecting the speed of aircraft difficult to impossible when the laser beam is emitted through the turbulent air and encounters eddy currents and bow shock waves flowing over surface of aircraft from the leading edge of the wing.

The illustrative embodiments recognize and take into account that a laser beam using a longer wavelength may work better under these flight conditions. By selecting the two wavelengths, one wavelength for normal operating conditions in which turbulence is absent, and another wavelength for abnormal operating conditions in which turbulence is present. The use of two wavelengths for different operating conditions can improve the performance in detecting the speed of the aircraft during various flight conditions for the aircraft.

The illustrative embodiments provide a method, apparatus, system, and computer program product for detecting speed of an aircraft. In one illustrative example, a method is provided for detecting a speed of an aircraft. A first backscatter light generated in response to emitting a first laser beam into the atmosphere from the aircraft is received. The laser beam has a first wavelength. A beat frequency is measured using a first backscatter light detected in response to first laser beam and a first reference light derived from the first laser beam in response a power of the first backscatter light being greater than a threshold. A second backscatter light in response to emitting a second laser beam into the atmosphere from the aircraft is received when the power of the first backscatter light not being greater than the threshold. The second laser beam has a second wavelength that is longer than the first wavelength. The beat frequency is measured using the second backscatter light and a second reference light derived from the second laser beam in response to the power of the first backscatter light not being greater than the threshold. The speed of the aircraft is determined using the beat frequency.

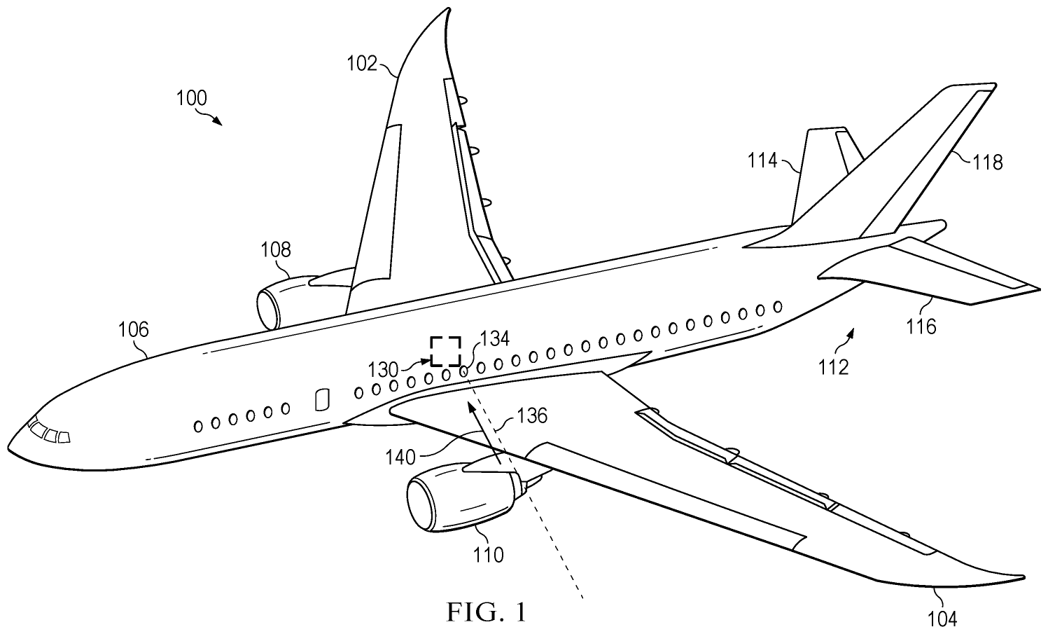

With reference now to the figures, and in particular, with reference to FIG. 1, an illustration of an aircraft is depicted in accordance with an illustrative embodiment. In this illustrative example, commercial airplane 100 has wing 102 and wing 104 attached to body 106. Commercial airplane 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Commercial airplane 100 is an example of an aircraft in which speed detection system 130 can be implemented in accordance with an illustrative embodiment. In this illustrative example, speed detection system 130 can operate to emit laser beams from window 134 during flight or other movement of commercial airplane 100. Speed detection system 130 can detect backscatter light 140 generated in response to emitting these laser beams.

In this depicted example, speed detection system 130 emits laser beam 136 from window 134 in different directions. Backscatter light 140 is generated in response to emitting laser beam 136. In this example, backscatter light 140 is detected by speed detection system 130. In this depicted example, backscatter light 140 is used to determine the speed of commercial airplane 100.

In this example, speed detection system 130 interferes backscatter light 140 with a reference light. The reference light is derived from laser beam 136. This interference of backscatter light 140 with the reference light results in an interference light having a beat frequency. The beat frequency for the interference light is used by speed detection system 130 to determine the speed of commercial airplane 100.

In this illustrative example, different wavelengths can be used to emit laser beam 136. For example, laser beam 136 can have a first wavelength that can be used during desired operating conditions in which turbulence is absent. Laser beam 136 can have a second wavelength that can be used during desired or ideal operating conditions and a second wavelength that is used under abnormal or non-ideal operating conditions. The first wavelength is shorter than the second wavelength and can be selected to be sufficiently short such that increased scattering of the laser beam occurs in the atmosphere. This selection of the first wavelength can increase backscatter light 140 received in response to emitting laser beam 136.

However, turbulence in which turbulent airflow is present can disrupt laser beam 136 having the first wavelength. The first wavelength can result in increased disruption of the laser beam 136 when a non-ideal operating conditions exist such as the presence of turbulence. In this example, turbulence can be a condition in the speed of the air at a point that is continuously undergoing changes in magnitude and direction. Turbulence can be a flow of air in which the air undergoes irregular fluctuations or mixing as compared to laminar airflow in which the air moves in smooth paths or layers.

In response to the turbulence in the non-ideal operating condition, speed detection system 130 can change the wavelength of the laser beam 136 from first wavelength to second wavelength. The second wavelength is selected such that when laser beam 136 passes through turbulence, distortion of laser beam 136 is not so great such that backscatter light 140 received by speed detection system 130 cannot be processed to determine the speed of commercial airplane 100. In other words, although some distortion of laser beam 136 can occur in response to turbulence, backscatter light 140 has a sufficient amount and quality that can be used by speed detection system 130 to detect the speed of commercial airplane 100.

Illustration of speed detection system 130 for commercial airplane 100 is not meant to limit the manner in which other illustrative examples can be implemented. For example, one or more speed detection systems can be present in addition to speed detection system 130. Further, in other illustrative examples, one or more wavelengths in addition to the first wavelength and the second wavelength for laser beam 136 can be used.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

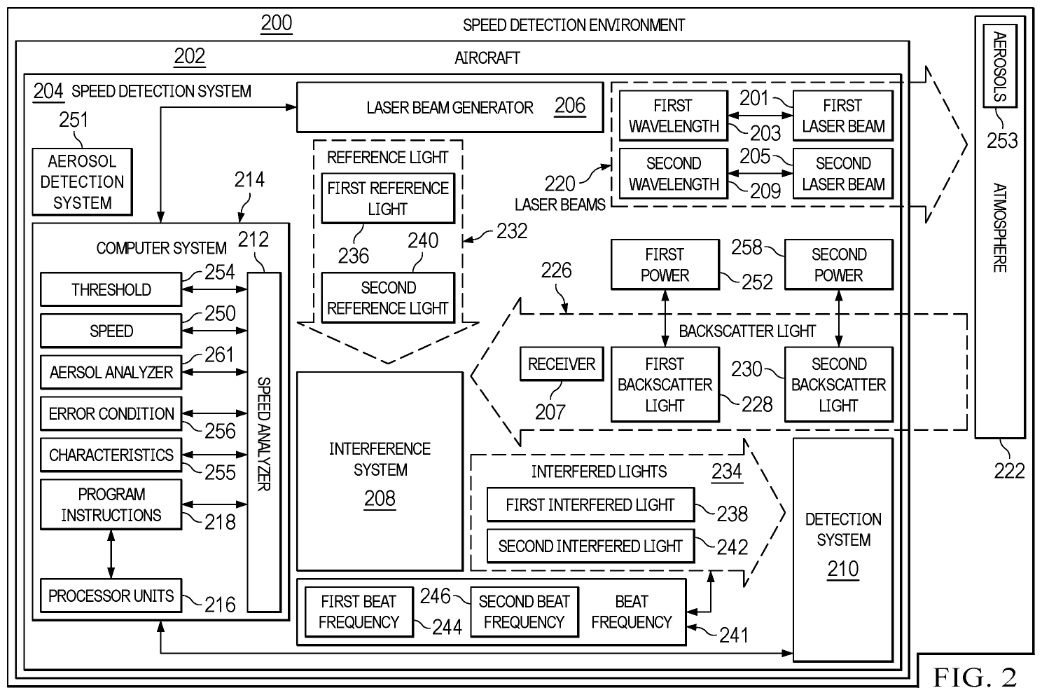

With reference now to FIG. 2, an illustration of a block diagram of a speed detection environment is depicted in accordance with an illustrative embodiment. In this illustrative example, speed detection environment 200 is an environment in which the speed for aircraft 202 can be detected using speed detection system 204. Commercial airplane 100 in FIG. 1 is an example of one implementation for aircraft 202. Aircraft 202 can be selected from a group comprising one of a commercial aircraft, a commercial airplane, a tilt-rotor aircraft, a tilt wing aircraft, a vertical takeoff and landing aircraft, an electrical vertical takeoff and landing aircraft, a personal air aircraft, a military aircraft, a fighter jet, and other types of aircraft.

In this illustrative example, speed detection system 204 comprises a number of different components. As depicted, speed detection system 204 comprises laser beam generator 206, receiver 207, interference system 208, detection system 210, and speed analyzer 212. These components are hardware components that also can include software used in operating the hardware components.

Laser beam generator 206 is used to generate laser beams 220 in speed detection system 204 and can be a LIDAR system that emits coherent light such as laser beams 220. In this illustrative example, speed analyzer 212 can control laser beam generator 206 to generate laser beams 220.

In this depicted example, first laser beam 201 has first wavelength 203 and second laser beam 205 has second wavelength 209. Speed analyzer 212 can control laser beam generator 206 to selectively emit first laser beam 201 and second laser beam 205. For example, laser beam generator 206 can be controlled to emit first laser beam 201, second laser beam 205, or both first laser beam 201 and second laser beam 205.

As depicted, first laser beam 201 has first wavelength 203. Second laser beam 205 has second wavelength 209. In this illustrative example, first wavelength 203 is shorter than second wavelength 209.

In this illustrative example, backscatter light 226 is generated in response to laser beams 220. Backscatter light 226 occurs in response to laser beams 220 being scattered by particles or other objects in atmosphere 222.

For example, first backscatter light 228 is generated in response to emitting first laser beam 201 into atmosphere 222. Second backscatter light 230 is generated in response to emitting second laser beam 205 into atmosphere 222.

In this illustrative example, speed analyzer 212 can also control the wavelengths for these laser beams emitted by laser beam generator 206. For example, speed analyzer 212 can select values for first wavelength 203 and second wavelength 209. In the illustrative example, first wavelength 203 for first laser beam 201 is selected to have a shorter wavelength than second wavelength 209 for second laser beam 205.

In this illustrative example, receiver 207 receives backscatter light 226 generated in response to emitting laser beams 220 into atmosphere 222 from aircraft 202. The reception of backscatter light 226 can also be referred to as detecting backscatter light 226. In other words, the presence of backscatter light 226 can be detected by receiver 207 receiving backscatter light 226.

For example, receiver 207 can receive first backscatter light 228 in backscatter light 226 generated in response to emitting first laser beam 201 into atmosphere 222 from aircraft 202. Receiver 207 can also receive second backscatter light 230 in backscatter light 226 generated in response to emitting second laser beam 205 into atmosphere 222 from aircraft 202.

In this illustrative example, interference system 208 interferes backscatter light 226 with reference light 232 to form interfered light 234. For example, interference system 208 interferes first backscatter light 228 with first reference light 236 to generate first interfered light 238. First reference light 236 is derived from first laser beam 201.

Additionally, interference system 208 interferes second backscatter light 230 with second reference light 240 to generate second interfered light 242. Second reference light 240 is derived from second laser beam 205.

In this illustrative example, the derivation of a reference light from a laser beam can be performed in a number of different ways. For example, reference light 232 can be coherent light split from first laser beam 201 emitted by laser beam generator 206. In another illustrative example, reference light 232 can be coherent light generated by the components that generate coherent light for first laser beam 201. For example, first reference light 236 can be generated using the same oscillator, modulator, and fiber amplifier used to generate first laser beam 201.

Detection system 210 measures beat frequency 241 for interfered light 234. For example, detection system 210 can measure beat frequency 241 using first backscatter light 228 detected in response to first laser beam 201 and first reference light 236. In this example, beat frequency 241 is measured for first interfered light 238 generated from interfering the backscatter light and reference light. This beat frequency can also be referred to as first beat frequency 244.

Additionally, detection system 210 can measure beat frequency 241 using second backscatter light 230 detected in response to second laser beam 205 and second reference light 240. In this example, beat frequency 241 is measured for second interfered light 242 generated from interfering the backscatter and reference light. This beat frequency can also be referred to as second beat frequency 246.

In this illustrative example, detection system 210 is in communication with speed analyzer 212 in computer system 214. Detection system 210 outputs beat frequency 241 to speed analyzer 212. Speed analyzer 212 can determine speed 250 of aircraft 202 using beat frequency 241. For example, detection system 210 can measure and output first beat frequency 244 and second beat frequency 246 and send these beat frequencies to speed analyzer 212 for use in determining speed 250 of aircraft 202.

Speed analyzer 212 can be implemented in software, hardware, firmware or a combination thereof. When software is used, the operations performed by speed analyzer 212 can be implemented in program instructions configured to run on hardware, such as a processor unit. When firmware is used, the operations performed by speed analyzer 212 can be implemented in program instructions and data and stored in persistent memory to run on a processor unit. When hardware is employed, the hardware may include circuits that operate to perform the operations in speed analyzer 212.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 214 is a physical hardware system and includes one or more data processing systems. When more than one data processing system is present in computer system 214, those data processing systems are in communication with each other using a communications medium. The communications medium may be a network. The data processing systems may be selected from at least one of a computer, a server computer, a tablet, or some other suitable data processing system.

As depicted, computer system 214 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond and process instructions and program code that operate a computer. When the number of processor units 216 execute program instructions 218 for a process, the number of processor units 216 can be one or more processor units that are on the same computer or on different computers. In other words, the process can be distributed between processor units 216 on the same or different computers in a computer system 214 further, the number of processor units 216 can be of the same type or different type of processor units. For example, a number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, speed analyzer 212 controls laser beam generator 206 to emit first laser beam 201 such that first backscatter light 228 is generated and received by receiver 207. This backscatter light is used by interference system 208 to generate first interfered light 238 having first beat frequency 244.

In this example, speed analyzer 212 can determine first power 252 for first backscatter light 228. In response to first power 252 for first backscatter light 228 being greater than threshold 254, speed analyzer 212 determines speed 250 using first beat frequency 244.

In the depicted example, threshold 254 is a value for power in backscatter light that is considered sufficient to measure speed 250. For example, threshold 254 can be selected such that the power of the backscatter light has a signal to noise ratio (SNR) that can be used to determine speed 250 of aircraft 202.

This value for threshold 254 can be determined through experimental testing, simulations, and other techniques. The value used for threshold 254 can take into account factors such as desired accuracy, tolerances of components in speed detection system 204, and other suitable factors. The value can be actual power measured, a signal-to-noise ratio for power, or some other suitable form.

In this example, in response to first power 252 of first backscatter light 228 not being greater than threshold 254, speed analyzer 212 controls laser beam generator 206 to emit second laser beam 205 into atmosphere 222 such that receiver 207 receives second backscatter light 230. This second backscatter light is used by interference system 208 to generate second interfered light 242 having second beat frequency 246.

In this example, speed analyzer 212 determines speed 250 of aircraft 202 using second beat frequency 246 in response to first power 252 of first backscatter light 228 not being greater than threshold 254. Further, in determining speed 250 of aircraft 202 using second beat frequency 246, speed analyzer 212 can determine whether second power 258 of second backscatter light 230 is sufficient to determine speed 250 with a desired level of accuracy. In this example, speed analyzer 212 can indicate error condition 256 in response to second power 258 of second backscatter light 230 not being greater than threshold 254.

In other illustrative examples, speed analyzer 212 can control laser beam generator 206 to emit both first laser beam 201 and second laser beam 205 at the same time or substantially the same time into atmosphere 222. With this example, backscatter light 226 for both laser beams are received and used to generate first interfered light 238 having first beat frequency 244 and second interfered light 242 having second beat frequency 246. In this illustrative example, speed analyzer 212 can receive both first beat frequency 244 and second beat frequency 246 from detection system 210. With this example, speed analyzer 212 can select which beat frequency to use based on first power 252 for first backscatter light 228 and second power 258 for the second backscatter light 230. In another illustrative example, both beat frequencies can be used to determine two speeds that are averaged to obtain speed 250 for aircraft 202.

In this illustrative example, first power 252 for first backscatter light 228 and second power 258 for second backscatter light 230 can be measured in a number of different ways. For example, first power 252 for first backscatter light 228 can be measured indirectly. With this indirect measurement, a power meter or other device can be included in detection system 210 that indirectly measures first power 252 by measuring the power of first interfered light 238. In this example, the power of first interfered light 238 can provide an indication of whether the amount of power needed to determine speed 250 with the desired level of accuracy is present. With this example, threshold 254 can be based on the power present in first interfered light 238 that was generated using first backscatter light 228.

In another example, first power 252 for first backscatter light 228 can be directly measured. With this example, first power 252 for first backscatter light 228 is measured using a power meter or other device that is located in or at receiver 207. In this example, first power 252 for first backscatter light 228 is measured prior to interfering first backscatter light 228 with first reference light 236.

In addition to selecting threshold 254, speed analyzer 212 can select at least one of first wavelength 203 or second wavelength 209. In one illustrative example, first wavelength 203 is selected such that first power 252 of first backscatter light 228 is greater than threshold 254 in response to an absence of a turbulent airflow in a first path of the first laser beam emitted from the aircraft 202. With this example, second wavelength 209 is selected such that power 248 for second backscatter light 230 is greater than threshold 254 in response to a presence of the turbulent airflow in a second path of the second laser beam emitted from the aircraft.

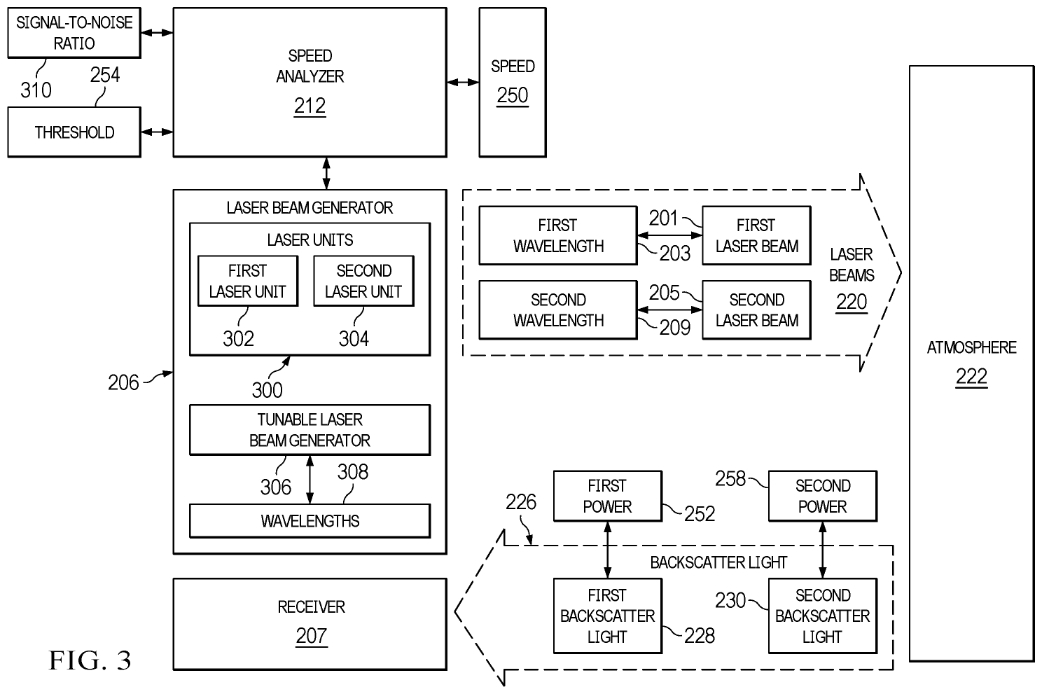

With reference next to FIG. 3, an illustration of a block diagram of a laser generator is depicted in accordance with an illustrative embodiment. In the illustrative examples, the same reference numeral may be used in more than one figure. This reuse of a reference numeral in different figures represents the same element in the different figures.

In one illustrative example, laser beam generator 206 can comprise laser units 300. Each laser beam unit in laser units 300 can generate a laser beam in laser beams 220 emitted by laser beam generator 206. Speed analyzer 212 can control the operation of laser units 300 in emitting laser beams 220.

In this illustrative example, each laser beam unit comprises components needed to generate and emit a laser beam and laser beams 220. For example, components for a laser beam unit can comprise an oscillator, a modulator, and fiber amplifier. The oscillator generates coherent light. The modulator can modulate or adjust various properties for the coherent light including at least one of a frequency, a wavelength, an amplitude, intensity, a phase, a polarization, or other properties. The fiber amplifier can amplifier or boost the coherent light.

For example, laser units 300 can include first laser unit 302 and second laser unit 304. In this example, first laser unit 302 generates first coherent light for first laser beam 201 having first wavelength 203. Further, in this example, second laser unit 304 generates second coherent light for second laser beam 205 having second wavelength 209. Additional laser units can be present for producing additional laser beams for emission from laser beam generator 206.

In another illustrative example, laser beam generator 206 can be tunable laser beam generator 306. With this example, tunable laser beam generator 306 can generate multiple laser beams in laser beams 220 with different properties such as different wavelengths. In one illustrative example, tunable laser beam generator 306 can generate both first laser beam 201 having first wavelength 203 and second laser beam 205 having second wavelength 209 for emission from tunable laser beam generator 306.

In this example, speed analyzer 212 can control tunable laser beam generator 306 to change wavelengths to generate the different laser beams with the different wavelengths. In this illustrative example, speed analyzer 212 can control tunable laser beam generator 306 to scan wavelengths 308 to select first wavelength 203 and second wavelength 209. In other words, first wavelength 203 and second wavelength 209 can be dynamic or changed by tunable laser beam generator 306 during operation of tunable laser beam generator 306 in laser beam generator 206 while aircraft 202 is in flight.

For example, speed analyzer 212 can control tunable laser beam generator 306 to adjust or select first wavelength 203 and second wavelength 209. The selection of first wavelength 203 can be such that first power 252 of first backscatter light 228 is greater than threshold 254 in response to an absence of a turbulent airflow in a first path of first laser beam 201 emitted from aircraft 202. The selection of second wavelength 209 can be such that second power 258 of second backscatter light 230 is greater than threshold 254 in response to a presence of the turbulent airflow in a second path of second laser beam 205 emitted from aircraft 202.

In this illustrative example, speed analyzer 212 can determine signal-to-noise ratio 310 from first power 252 and second power 258. With this example, threshold 254 can be a value for signal-to-noise ratio 310 such that the power of a backscatter light is sufficient for use in determining speed 250.

In this illustrative example, the analysis can include using a fast Fourier transform to change power detected over time in a power versus time curve to a power versus frequency curve. With this example, if a frequency in the frequencies has a power that exceeds threshold 254, then that frequency is the frequency for the beat frequency 241. If none of the frequencies have a power that exceeds threshold 254, a beat frequency cannot be detected in interfered light 234 in this example.

With this illustrative example, first wavelength 203 and second wavelength 209 can change during the flight of aircraft 202 in response to changing conditions in the environment around aircraft 202. In other words, adjustments of first wavelength 203 and second wavelength 209 do not require performing changes in wavelength while aircraft is on the ground or during maintenance of aircraft 202.

Further, the selection of first wavelength 203 and second wavelength 209 can be performed continuously in some illustrative examples. In other illustrative examples, this selection can be performed periodically after a period such as two seconds, one minute, three minutes, an hour, or some other period of time. Additionally, the selection of the wavelengths can be performed in response to a nonperiodic event such as the detection of turbulence or the speed of the aircraft reaching a supersonic speed.

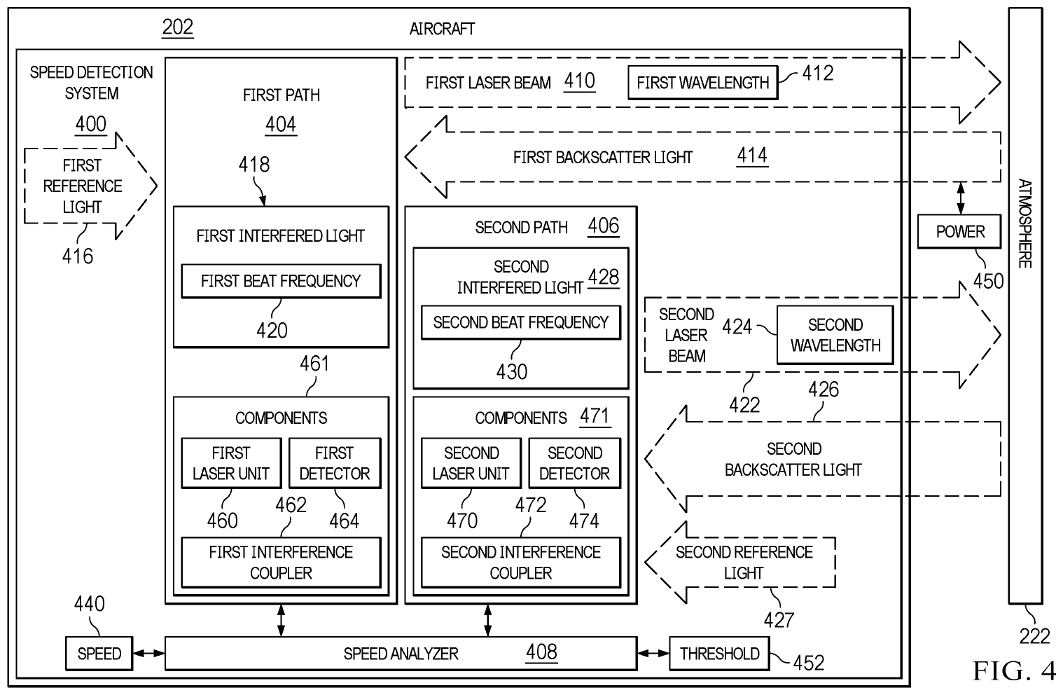

Turning next to FIG. 4, an illustration of a speed detection system is depicted in accordance with an illustrative embodiment. In this illustrative example, speed detection system 400 can be implemented in aircraft 202 in speed detection environment 200 in FIG. 2. In this depicted example, speed detection system 400 implements redundancy for detecting the speed of aircraft 202. In this illustrative example, speed detection system 400 comprises a number of different components. These components are hardware components in the depicted examples. As depicted, speed detection system 400 comprises first path 404, second path 406, and speed analyzer 408.

In this example, first path 404 emits first laser beam 410 having first wavelength 412. First path 404 interferes first backscatter light 414 received in response to emitting first laser beam with first reference light 416 derived from first laser beam 410 to form first interfered light 418 with first beat frequency 420. First path 404 measures first beat frequency 420 for first interfered light 418.

In the depicted example, second path 406 emits second laser beam 422 having second wavelength 424. Second path 406 interferes second backscatter light 426 received in response to emitting second laser beam 422 with second reference light 427 derived from second laser beam 422 to form second interfered light 428 with second beat frequency 430. Second path 406 measures second beat frequency 430 for the second interfered light 428.

In this example, speed analyzer 408 is in communication with first path 404 and second path 406. Speed analyzer 408 is configured to receive first beat frequency 420 from first path 404 and receive second beat frequency 430 from second path 406. Speed analyzer 408 is configured to determine speed 440 for aircraft 202 using first beat frequency 420 and determine speed of the aircraft using second beat frequency 430 in response to first path 404 being out of tolerance.

In addition to providing redundancy, speed detection system 400 can also be used to determine speed with a desired level of accuracy in different operating conditions. For example, first laser beam 410 with first wavelength 412 can be used during normal operation of aircraft 202 to determine speed 440 of aircraft 202 when turbulent airflow across the path of first laser beam 410 is absent. When turbulent airflow is present across the path of first laser beam 410, second laser beam 422 having second wavelength 424 can be emitted by speed detection system 400 to determine speed 440 of aircraft 202 to receive second backscatter light 426.

For example, speed analyzer 408 is configured to determine speed 440 of aircraft 202 using first beat frequency 420 in response to first backscatter light 414 having power 450 that is greater than threshold 452. Speed analyzer 408 is configured to determine speed 440 of aircraft 202 using second beat frequency 430 in response to first backscatter light 414 having power 450 that is not greater than threshold 452. Thus, speed detection system 400 can also be used to determine speed 440 of aircraft 202 for different types of conditions in addition to providing redundancy.

In this illustrative example, first path 404 can include a number of different types of components 461. For example, first path 404 can include first laser unit 460, first interference coupler 462, and first detector 464.

In this example, first laser unit 460 emits first laser beam 410. First interference coupler 462 receives first backscatter light 414 generated in response to emitting first laser beam 410 and interferes first backscatter light 414 with first reference light 416 to form first interfered light 418. First detector 464 is connected to first interference coupler 462 and first detector 464 measures first beat frequency 420 for first interfered light 418 output by first interference coupler 462.

In this depicted example, second path 406 can include a number of different types of components 471. These components can include, for example, second laser unit 470, second interference coupler 472, and second detector 474.

As depicted, second laser unit 470 emits second laser beam 422. Second interference coupler 472 receives second backscatter light 426 generated in response to emitting second laser beam 422 and interferes second backscatter light 426 with second reference light 427 to form second interfered light 428. Second detector 474 is connected to second interference coupler 472. Second detector 474 measures second beat frequency 430 for second interfered light 428 output by second interference coupler 472.

These paths also include other components not shown. For example, the paths have connections between components such as optical fibers and wired connectors that connect the different components to each other.

The illustration of speed detection environment in the different components in FIGS. 2-4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more laser beams having one or more additional wavelengths can be used in addition to first laser beam 201 having first wavelength 203 and second laser beam 205 having second wavelength 209. The additional laser beams having additional wavelengths can be selected based on the operating conditions around aircraft 202. For example, different wavelengths can be selected based on the amount of turbulence that is present.

In another example, speed detection system 204 can operate as aerosol detection system 251 to detect aerosols 253 in atmosphere 222. Aerosols 253 can take a number of different forms. For example, aerosols 253 can be natural inorganic materials such as fine dust, sea salt, water droplets, and ice crystals. Aerosols 253 can also be natural organic materials such as smoke, pollen, spores, bacteria, and insect parts. In these examples, aerosols 253 can also be anthropogenic products of combustion such as smoke, ash, and dust. These particles can vary in size. For example, aerosols 253 can be from about 0.002 μm to about 100 μm.

In this example implementation, laser beams 220 emitted into atmosphere 222 and backscatter light 226 received in response to these laser beams can be used determine a set of characteristics 255 for aerosols 253. The set of characteristics 255 can be determined by speed analyzer 212 using beat frequencies determined from interfering backscatter light with reference light. When determining the set of characteristics 225, speed analyzer 212 can be referred to as an aerosol analyzer 261. These characteristics can be, for example, at least one of an aerosol concentration, a particle size, or other characteristics. For example, threshold 254 can be a power level for a beat frequency that is selected to indicate the concentration of aerosol concentration. When the power of the beat frequency detected through measuring the power in interfered light 234 is equal to threshold 254, the concentration level for aerosols 253 is concentration selected for threshold 254. If the power of the interfered light at the beat frequency is greater than threshold 254, the concentration for aerosols 253 is at least the concentration selected for threshold 254.

The concentration represented by threshold 254 typically can be identified through experimentation and simulations to identify the concentration level for aerosols 253 at the power level of selected threshold 254. In other illustrative examples, one or more additional thresholds can be present in addition to threshold 254 that indicate other concentrations of aerosol levels. Thresholds and similar analysis can be performed by speed analyzer 212 to determine other characteristics in the set of characteristics 255. As another example, polarization changes in the interfered light can indicate a presence of ice crystals or insect parts.

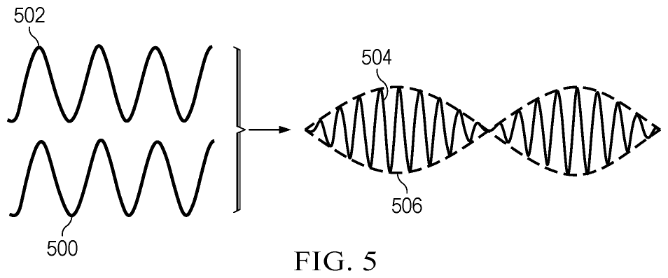

Turning next to FIG. 5, an illustration of light used to determine the speed of the vehicle is depicted in accordance with an illustrative embodiment. In the illustrative example, a pair of backscatter lights is detected in response to emitting a pair of laser beams.

In this illustrative example, backscatter light 500 and reference light 502, which are coherent light. For example, backscatter light 500 can be first backscatter light 228 and reference light 502 can be first reference light 236. In another example, backscatter light 500 can be second backscatter light 230 and reference light 502 can be second reference light 240

In this example, a difference is present between the frequency for backscatter light 500 and reference light 502. This difference in frequency can be such that the interference of the backscatter light 500 and reference light 502 results in a beat frequency.

As depicted in this example, when backscatter light 500 and reference light 502 are interfered or combined with each other, interfered light 504 with beat frequency 506 is generated. In this example, beat frequency 506 can be measured by measuring the power of interfered light 504. Beat frequency 506 can be used to determine the speed of the aircraft 202.

However, when turbulent airflow is present, the quality of backscatter light 500 received in response to emitting a laser beam through the turbulent airflow can be sufficiently poor that interfering backscatter light 500 with reference light 502 does not contain interfered light 504 with beat frequency 506 that can be detected.

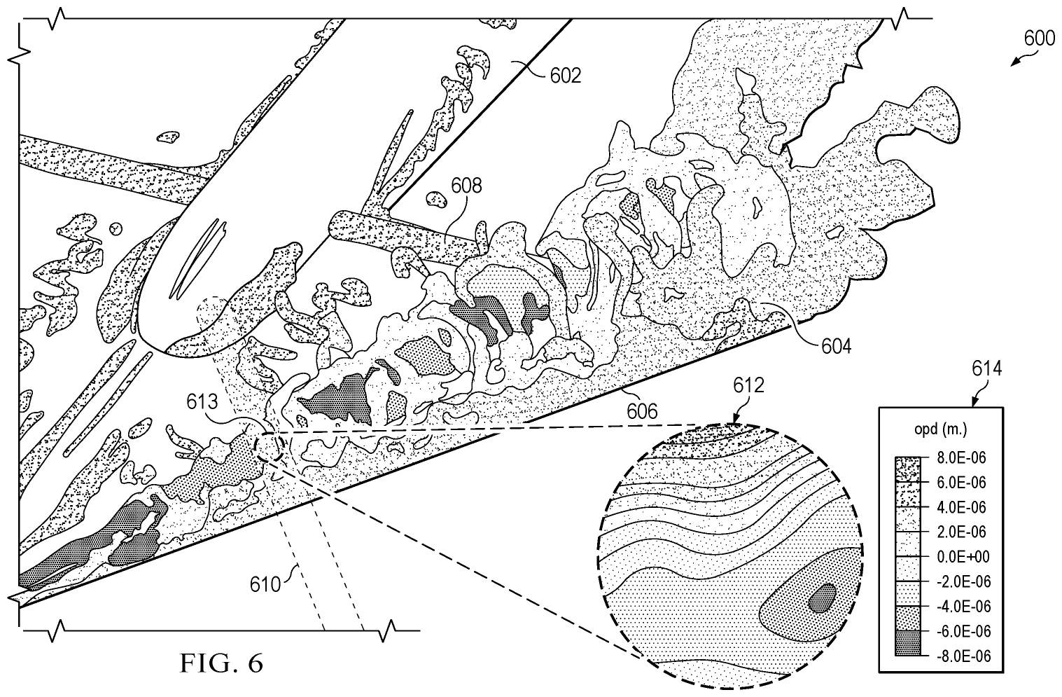

With reference now to FIG. 6, a pictorial illustration of airflow over the surface of an aircraft is depicted in accordance with an illustrative embodiment. In this illustrative example, airflow 600 is shown over aircraft 602. In this example, airflow 600 includes turbulent airflow 604 over leading edge 606 of wing 608.

In this example, laser beam 610 is emitted from aircraft 602. Turbulent airflow 604 is present across the path of laser beam 610. Turbulent airflow 604 changes the optical path for laser beam 610. The change in optical path occurs through changing densities within turbulent airflow 604. As the density of the air increases in turbulent airflow 604, the optical path increases in length. As the density decreases, the optical path decreases in length.

For example, section 612 is an enlarged view of section 613 where laser beam 610 propagates through turbulent airflow 604. As can be seen in section 612, the turbulent airflow has different densities identified by legend 614.

When the change in the optical path is not even, backscatter light is not received in a manner that enables determining a beat frequency to detect the speed of aircraft 622. As the frequency of laser beam 610 increases, increased dispersion of laser beam 610 results from turbulent airflow 604. Decreasing the wavelength of laser beam 610 can reduce the effects of turbulent airflow 604. In other words, the amount dispersion is reduced at lower wavelengths. Less scattering of laser beam 610 traveling through turbulent airflow occurs with lower wavelengths.

As a result, the first wavelength can be selected for a laser beam 610 that provides desired performance in determining the speed of aircraft 602 during normal conditions in which turbulent airflow 604 is absent or reduced across the path of laser beam 610 such that the speed of aircraft 602 can be determined from backscatter light received in response to laser beam 610.

In this example, a second wavelength that is lower than the first wavelength can be selected for abnormal or undesired conditions in which turbulent airflow 604 is present across the path of laser beam 610. As result, the wavelength of laser beam 610 can be changed based on differing conditions with respect to the amount of turbulent airflow 604 that is present. In some illustrative examples, multiple wavelengths can be selected based on the amount of turbulent airflow 604 that is present. In one illustrative example, the speed detection system can scan or change the frequency of laser beam 610 until the backscatter light received in response laser beam 610 provides sufficient power to determine the speed of aircraft 602.

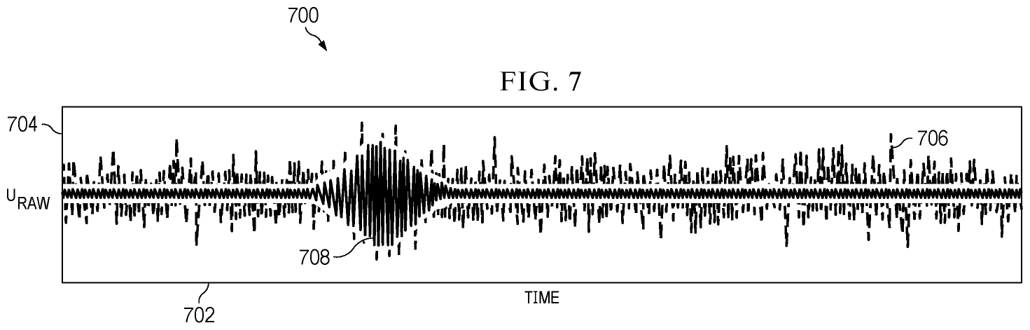

With reference next to FIGS. 7-10, illustrations of graphs of power for backscatter received in response to emitting laser beams are depicted in accordance with an illustrative embodiment.

With reference to FIG. 7, an illustration of a graph of interference light is depicted in accordance with an illustrative embodiment. As depicted, graph 700 is a graph of power versus time with X axis 702 being time and Y axis 704 being power. In this example line 706 is the power measured by detector that includes the power for the interfered light and noise. In this example, the power of the interfered light is an indirect measurement of the power in the backscatter light received in response to a laser beam.

Line 708 represents the power for just the interfered light. However, the power for the interfered light in line 708 may not be distinguishable from the noise in line 706 in the measurements made by the detector.

The power versus time curve shows power generated by many different frequencies that are not distinguishable in the power versus time curve. With this situation, the power versus time curve can be transformed into a power versus frequency curve using a fast Fourier transform (FFT).

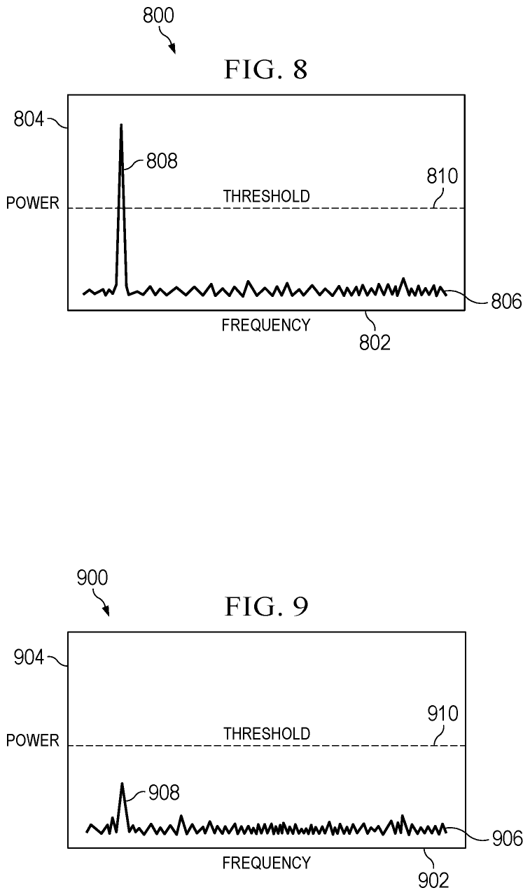

In FIG. 8, an illustration of a graph of an interference light having a power that is greater than a threshold is depicted in accordance with an illustrative embodiment. As depicted, graph 800 is a graph of power versus frequency with X axis 802 being frequency and Y axis 804 being power.

In this example, line 806 represents power for an interfered light and noise. Line 806 can be generated by performing a Fast Fourier transform (FFT) on a power versus time curve measured for the interfered light, such as line 706 in graph 700 in FIG. 7. As discussed in FIG. 7, line 706 represents measurements made by detector that includes the power for the interfered light and can also include power for noise. The power versus time curve shows power generated by many different frequencies that are not distinguishable in the power versus time curve. By performing a Fast Fourier Transform, the power for different frequencies is seen in line 806. This line can include the beat frequency and noise.

In this example, peak 808 is a candidate for a frequency that can be the beat frequency in the interfered light. Whether peak 808 is considered to be the frequency of the beat frequency can be determined by comparing the power of peak 808 to threshold 810.

In this example, peak 808 is greater than threshold 810. As a result, the frequency of peak 808 is considered the beat frequency for the interfered light. With peak 808 being greater than threshold 810, the beat frequency can be used to determine the speed of the aircraft with a desired level of accuracy.

Turning now to FIG. 9, an illustration of a graph of an interference light having a power that is not greater than a threshold is depicted in accordance with an illustrative embodiment. As depicted, graph 900 is a graph of power versus frequency with X axis 902 being frequency and Y axis 904 being power.

Line 906 represents power for different frequencies measured by a detector. In this example, peak 908 is peak with the highest power value in line 906. Peak 908, however, is not greater than threshold 910. With this situation, the wavelength of the laser beam can be changed such that peak 908 has a higher power that is greater than threshold 910 such as peak 808 in FIG. 8. In this example, threshold 810 and threshold 910 have the same value. In some other illustrative examples, different thresholds may be used for different wavelengths.

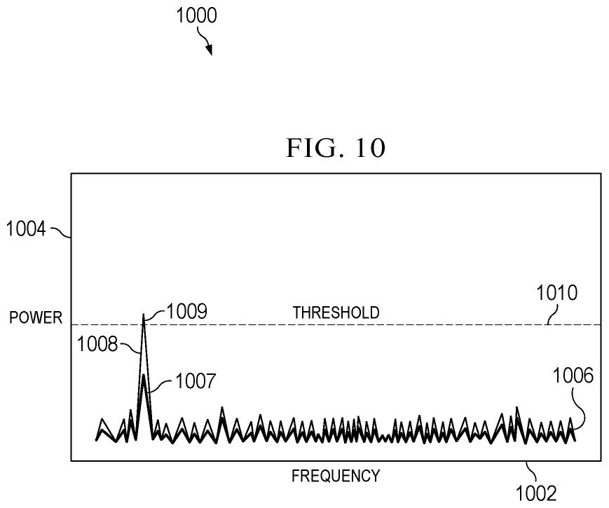

Turning next to FIG. 10, an illustration of a graph of interfered light from backscatter light generated from two laser beams having a power greater than a threshold is depicted in accordance with an illustrative embodiment. As depicted, graph 1000 is a graph of power versus frequency with X axis 1002 being frequency and Y axis 1004 being power.

Line 1006 represents power for different frequencies measured by a detector for a backscatter light received in response to laser. In this example, peak 1008 is peak with the highest power value in line 1006. Peak 1008, however, is not greater than threshold 1010.

In this illustrative example, line 1007 represents power for different frequencies measured by the detector for another backscatter light received in response to the laser beam having a different wavelength. In this example, line 1007 has peak 1009. Peak 1009 has the same frequency as peak 1008.

As depicted, line 1007 is added to line 1006. With this combination of peak 1008 and peak 1009, the power level is greater than threshold 1010. In this example, the frequency for peak 1008 and peak 1009 have a power level that is sufficient to identify the beat frequency for peak 1008 and peak 1009 as the beat frequency.

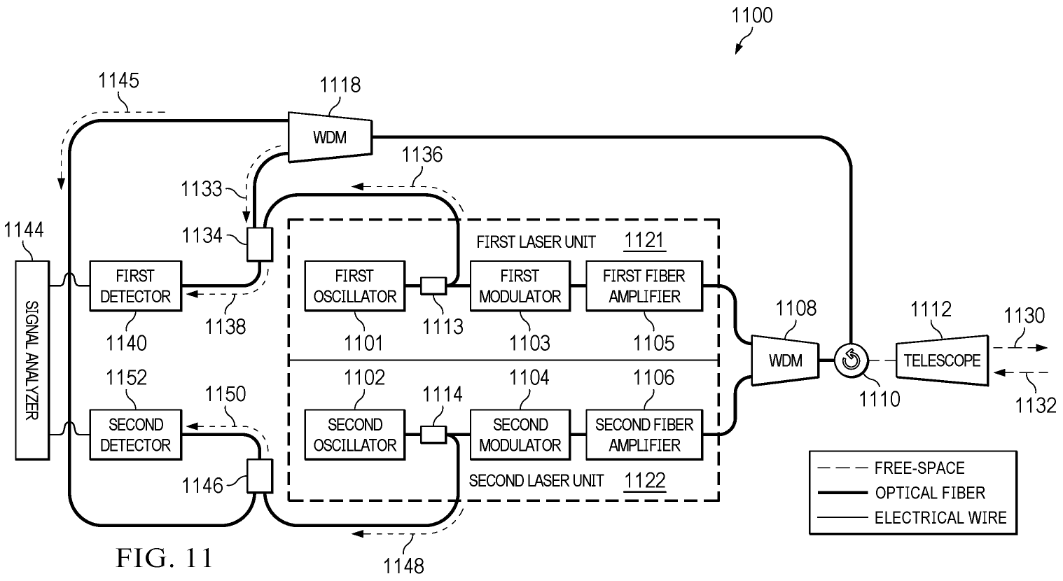

With reference next to FIG. 11, an illustration of a speed detection system is depicted in accordance with an illustrative embodiment. In this illustrative example, speed detection system 1100 is an example of an implementation for speed detection system 204 in FIG. 2.

As depicted, speed detection system 1100 comprises a number of different components. For example, some of the components in speed detection system 1100 are first oscillator 1101, second oscillator 1102, first modulator 1103, second modulator 1104, first fiber amplifier 1105, second fiber amplifier 1106, wavelength division multiplexer (WDM) 1108, circulator 1110, telescope 1112, first splitter 1113, and second splitter 1114. These components are examples of components that can be used to implement laser beam generator 206 in FIG. 2. In this example, first oscillator 1101, first modulator 1103, and first fiber amplifier 1105 are components in first laser unit 1121. First laser unit 1121 can be an example of first laser unit 460 in FIG. 4.

As depicted, second oscillator 1102, second modulator 1104, and second fiber amplifier 1106 are components in second laser unit 1122. Second laser unit 1122 can be an example of second laser unit 470 in FIG. 4.

In this example, the oscillators in these laser units generate coherent light that is used to emit laser beam 1130. For example, first laser unit 1121 can generate coherent light for emission as laser beam 1130 having a first wavelength for emission. Second laser unit 1122 can generate coherent light for emission as laser beam 1130 having a second wavelength. Laser beam 1130 can also be referred to as an outgoing laser light or transmitted laser.

The modulators in the laser units operate to manipulate one or more properties of the coherent light generated by the oscillators. For example, the modulators can change or manipulate the coherent light generated by the oscillators to obtain desired property such as intensity, phase, polarization, or other property. The fiber amplifiers operate to amplify or boost the coherent light generated by oscillators and modulated by the modulators.

As depicted, the fiber amplifiers are connected to wavelength division multiplexer 1108. Wavelength division multiplexer 1108 operates as a multiplexer to select which laser unit will have its coherent light emitted through telescope 1112 as laser beam 1130.

The selected coherent light is sent from wavelength division multiplexer 1108 to circulator 1110. Circulator 1110 is hardware optical circulator in the form of a port device such that light entering a port exits on the next port in circulator 1110. In this example, the coherent light from wavelength division multiplexer 1108 is sent to telescope 1112 by circulator 1110.

In response to the emission of laser beam 1130, backscatter light 1132 is received by telescope 1112. In this illustrative example, backscatter light 1132 can include backscatter light generated in response to laser beam 1130 having a first wavelength or backscatter light generated in response to laser beam 1130 having the second wavelength.

In other illustrative examples, backscatter light 1132 can include backscatter light generated in response to laser beams being emitted from telescope 1112 having both the first wavelength and the second wavelength. In other words, backscatter light 1132 can comprise first backscatter light generated in response to laser beam 1130 being emitted using coherent light with a first wavelength from first laser unit 1121 and second backscatter light generated response to laser beam 1130 being emitted using coherent light with a second wavelength from second laser unit 1122.

Backscatter light 1132 received by telescope 1112 is sent to wavelength division multiplexer (WDM) 1118. Wavelength division multiplexer 1118 operates to demultiplex backscatter light 1132 based on the wavelength of light within backscatter light 1132. For example, first backscatter light 1133 in backscatter light 1132 can be sent to first interference coupler 1134. First interference coupler 1134 can be, for example, a 3DB coupler. In this example, first interference coupler 1134 interferes first backscatter light 1133 with first reference light 1136.

As depicted, first reference light 1136 is derived from coherent light generated by first oscillator 1101. In this example, first reference light 1136 is split from this coherent light using first splitter 1113 which is connected to first interference coupler 1134.

First interfered light 1138 is sent from first interference coupler 1134 to first detector 1140. First detector 1140 measures the beat frequency in first interfered light 1138. The measurement of this beat frequency is sent to signal analyzer 1144. Signal analyzer 1144 can determine the speed of the aircraft using this beat frequency.

In this depicted example, wavelength division multiplexer 1118 can demultiplex backscatter light 1132 to separate second backscatter light 1145 from other wavelengths of backscatter light. This second backscatter light is sent to second interference coupler 1146. Second interference coupler 1146 can be, for example, a 3DB coupler.

As depicted, second interference coupler 1146 interferes second backscatter light 1145 with second reference light 1148 to form second interfered light 1150. Second interference coupler 1146 sends second interfered light 1150 to second detector 1152. In this example, second detector 1152 measures the beat frequency for second interfered light 1150 and sends the measured beat frequency to signal analyzer 1144. Signal analyzer 1144 can determine the speed for the aircraft using this beat frequency.

In the different illustrative examples, signal analyzer 1144 can selectively use one or other or both the frequencies measured by first detector 1140 and second detector 1152. In the illustrative example, in particular the beat frequency measured can be based on the conditions of the environment through which the aircraft is flying.

In another illustrative example, speed detection system 1100 can be an example of an implementation for speed detection system 400 in FIG. 4. For example, first path 404 can be implemented using first laser unit 1121, first interference coupler 1134, and first detector 1140. As another illustrative example, second path 406 can be implemented using second laser unit 1122, second interference coupler 1146. Further these paths can include optical fibers that connect these components to each other. The paths can also have some common components such as wavelength division multiplexer (WDM) 1108, circulator 1110, and wavelength division multiplexer (WDM) 1118.

The illustration of speed detection system 1100 in FIG. 11 is provided as an example of one implementation for speed detection system 204 in FIG. 2. This illustration is not meant to limit the manner in which speed analyzer 212 can be implemented in other illustrative examples. For example, wavelength division multiplexer (WDM) 1108 in FIG. 11 can be replaced with a beam splitter. In another example, first modulator 1103 and second modulator 1104 in FIG. 11 can be omitted when the laser beam system is a continuous wave LIDAR system. Additionally, optical fibers can be made solid or hollow core fibers. In other examples, the optical fibers can be omitted for a free-space LIDAR system.

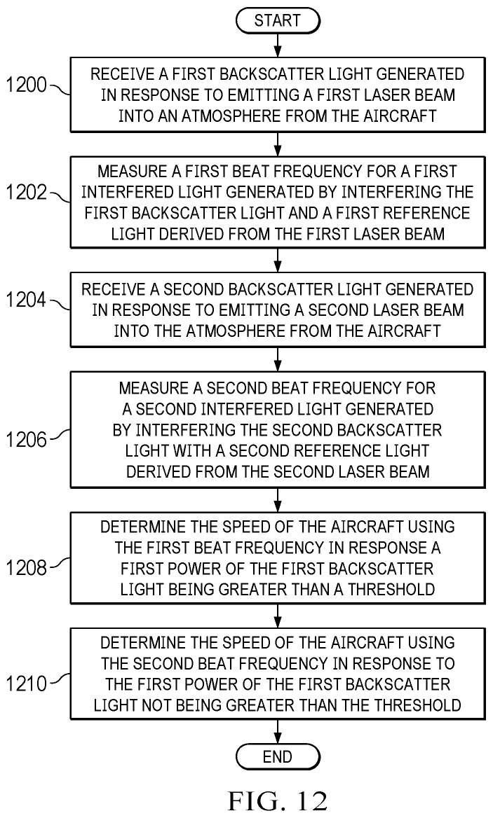

Turning next to FIG. 12, a flowchart of a process for detecting a speed of an aircraft is depicted in accordance with an illustrative embodiment. The process in FIG. 12 can be implemented in hardware, software, or both. When implemented in software, the process can take the form of program instructions that are run by one of more processor units located in one or more hardware devices in one or more computer systems. For example, the process can be implemented in speed detection system 204 in FIG. 2.

The process begins by receiving a first backscatter light generated in response to emitting a first laser beam into an atmosphere from the aircraft (operation 1200). In operation 1200, the first laser beam has a first wavelength. The process measures a first beat frequency for a first interfered light generated by interfering the first backscatter light and a first reference light derived from the first laser beam (operation 1202).

The process receives a second backscatter light generated in response to emitting a second laser beam into the atmosphere from the aircraft (operation 1204). In operation 1204, the second laser beam has a second wavelength. The process measures a second beat frequency for a second interfered light generated by interfering the second backscatter light with a second reference light derived from the second laser beam (operation 1206).

The process determines the speed of the aircraft using the first beat frequency in response a first power of the first backscatter light being greater than a threshold (operation 1208). The process determines the speed of the aircraft using the second beat frequency in response to the first power of the first backscatter light not being greater than the threshold (operation 1210). The process terminates thereafter.

In FIG. 12, the first wavelength can be selected such that the first power is greater than the threshold in response to an absence of a turbulent airflow in a first path of the first laser beam emitted from the aircraft. The second wavelength can be selected such that the first power is greater than the threshold in response to a presence of the turbulent airflow in a second path of the second laser beam emitted from the aircraft.

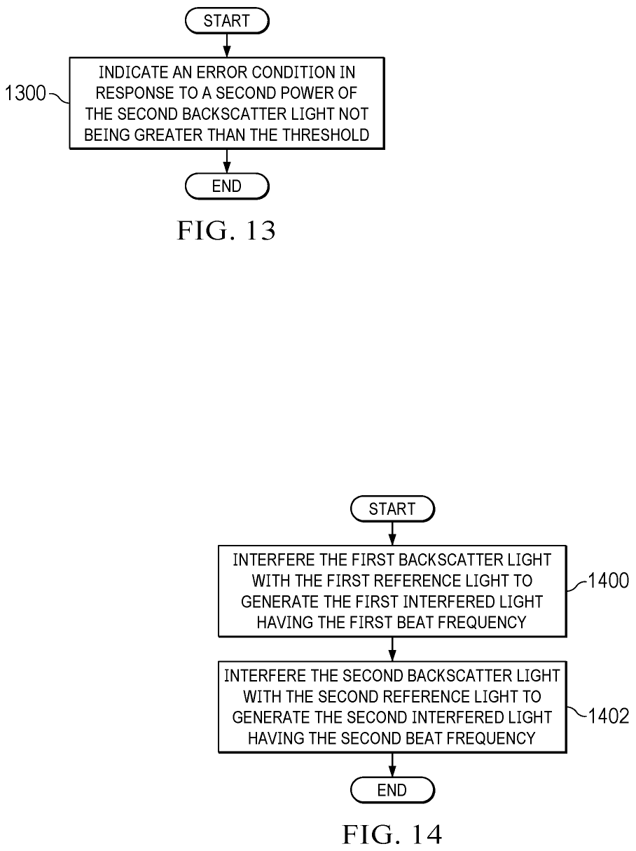

Turning next to FIG. 13, an illustration of a flowchart of a process for indicating an error is depicted in accordance with an illustrative embodiment. The process illustrated in FIG. 13 is an example of an additional operation that can be performed with the operations in FIG. 12.

The process indicates an error condition in response to a second power of the second backscatter light not being greater than the threshold (operation 1300). The process terminates thereafter. This error condition indicates that neither backscatter light received in response to the laser beams using the two different wavelengths resulted in backscatter light having sufficient power to determine the speed of the aircraft with the desired level of accuracy.

With reference to FIG. 14, an illustration of a flowchart of a process for interfering backscatter light is depicted in accordance with an illustrative embodiment. The process illustrated in FIG. 14 comprises additional operations that can be performed with the operations in FIG. 12.

The process begins by interfering the first backscatter light with the first reference light to generate the first interfered light having the first beat frequency (operation 1400). The process interferes the second backscatter light with the second reference light to generate the second interfered light having the second beat frequency (operation 1402). The process terminates thereafter.

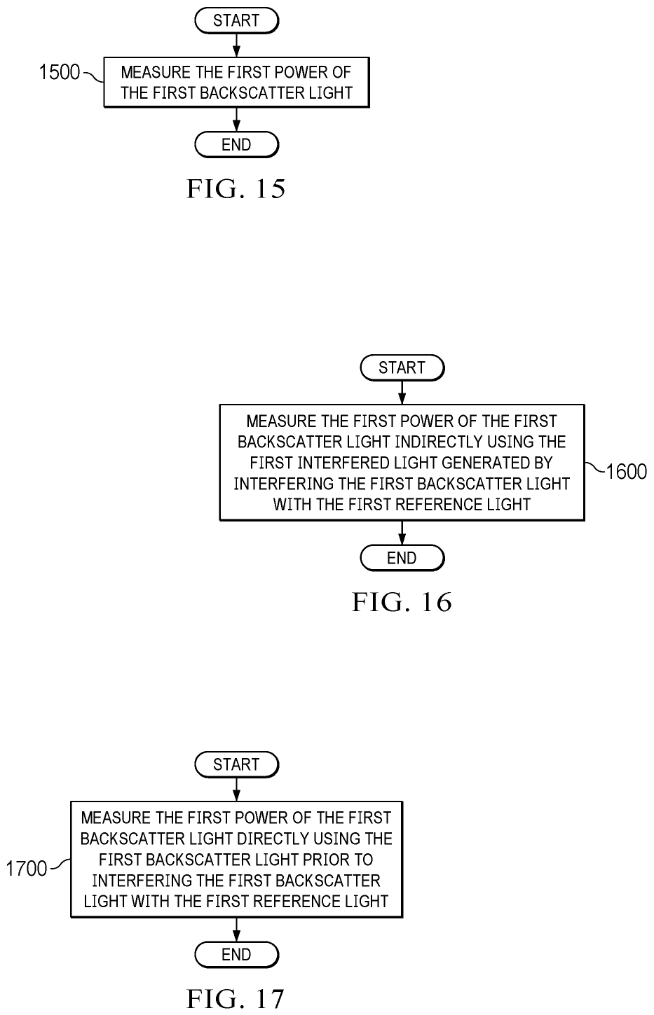

Turning to FIG. 15, an illustration of a flowchart of a process for measuring power is depicted in accordance with an illustrative embodiment. The process illustrated in FIG. 15 is an example of an additional operation that can be performed with the operations in FIG. 12.

The process measures the first power of the first backscatter light (operation 1500). The process terminates thereafter.

With reference to FIG. 16, an illustration of a flowchart of process for measuring power is depicted in accordance with an illustrative embodiment. The process illustrated in this figure is an example of one implementation for operation 1500 in FIG. 15.

The process measures the first power of the first backscatter light indirectly using the first interfered light generated by interfering the first backscatter light with the first reference light (operation 1600). The process terminates thereafter.

In FIG. 17, an illustration of a flowchart of process for measuring power is depicted in accordance with an illustrative embodiment. The process illustrated in this figure is an example of one implementation for operation 1500 in FIG. 15.

The process measures the first power of the first backscatter light directly using the first backscatter light prior to interfering the first backscatter light with the first reference light (operation 1700). The process terminates thereafter.

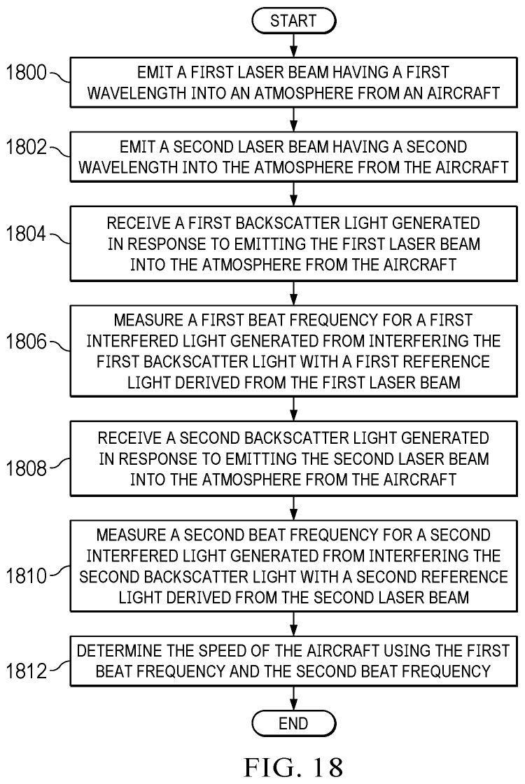

With reference to FIG. 18, an illustration of a flowchart of a process for detecting a speed of an aircraft is depicted in accordance with an illustrative embodiment. The process in FIG. 18 can be implemented in hardware, software, or both. When implemented in software, the process can take the form of program instructions that are run by one of more processor units located in one or more hardware devices in one or more computer systems. For example, the process can be implemented in speed detection system 204 in FIG. 2.

The process begins by emitting a first laser beam having a first wavelength into an atmosphere from an aircraft (operation 1800). The process emits a second laser beam having a second wavelength into the atmosphere from the aircraft (operation 1802).

The process receives a first backscatter light generated in response to emitting the first laser beam into the atmosphere from the aircraft (operation 1804). The process measures a first beat frequency for a first interfered light generated from interfering the first backscatter light with a first reference light derived from the first laser beam (operation 1806).

The process receives a second backscatter light generated in response to emitting the second laser beam into the atmosphere from the aircraft (operation 1808). The process measures a second beat frequency for a second interfered light generated from interfering the second backscatter light with a second reference light derived from the second laser beam (operation 1810).

The process determines the speed of the aircraft using the first beat frequency and the second beat frequency (operation 1812). The process terminates thereafter.

In FIG. 18, the first wavelength can be selected such that a first power of the first backscatter light is greater than a threshold in response to an absence of a turbulent airflow in a first path of the first laser beam emitted from the aircraft. The second wavelength can be selected such that a second power of the second backscatter light is greater than the threshold in response to a presence of the turbulent airflow in a second path of the second laser beam emitted from the aircraft.

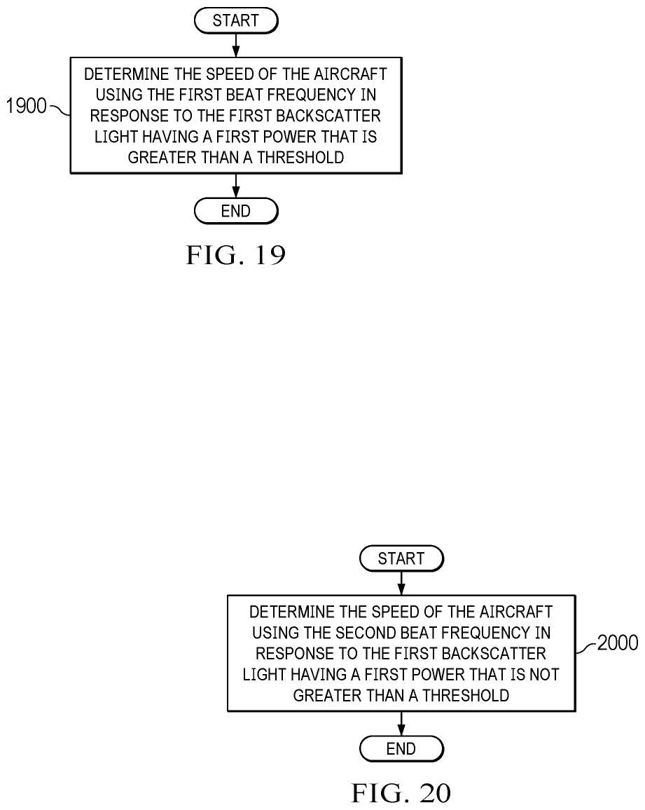

Turning next to FIG. 19, a flowchart of a process for determining the speed of an aircraft is depicted in accordance with an illustrative embodiment. The process illustrated in FIG. 19 is an example of one implementation for operation 1812 in FIG. 18.

The process determines the speed of the aircraft using the first beat frequency in response to the first backscatter light having a first power that is greater than a threshold (operation 1900). The process terminates thereafter.

Turning to FIG. 20, another flowchart of a process for determining the speed of an aircraft is depicted in accordance with an illustrative embodiment. The process illustrated in FIG. 20 is an example of one implementation for operation 1812 in FIG. 18.

The process determines the speed of the aircraft using the second beat frequency in response to the first backscatter light having a first power that is not greater than a threshold (operation 2000). The process terminates thereafter.

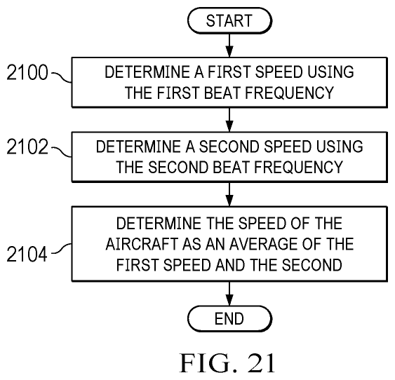

In FIG. 21, another flowchart of a process for determining the speed of an aircraft is depicted in accordance with an illustrative embodiment. The process illustrated in FIG. 21 is an example of one implementation for operation 1812 in FIG. 18.

The process begins by determining a first speed using the first beat frequency (operation 2100). The process determines a second speed using the second beat frequency (operation 2102).

The process determines the speed of the aircraft as an average of the first speed and the second speed (operation 2104). The process terminates thereafter.

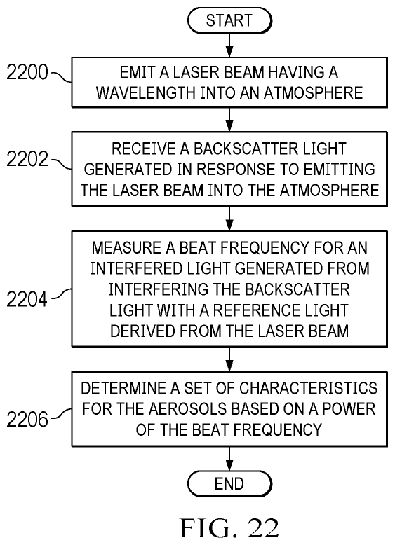

Turning next to FIG. 22, an illustration of a flowchart of a process for detecting aerosols is depicted in accordance with an illustrative embodiment. The process in FIG. 12 can be implemented in hardware, software, or both. When implemented in software, the process can take the form of program instructions that is run by one of more processor units located in one or more hardware devices in one or more computer systems. For example, the process can be implemented in speed detection system 204 in FIG. 2.

In this illustrative example, speed detection system 204 can also operate as an aerosol detection system to detect aerosols that may be present in the atmosphere around an aircraft. Further, speed detection system 204 can be implemented and other platforms other than aircraft to operate as an aerosol detection system. For example, when speed detection system 204 operates as an aerosol detection system, this detection system can be implemented in a platform such as from a mobile platform, a stationary platform, a land-based structure, an aquatic-based structure, and a space-based structure. More specifically, the platform can be a surface ship, a tank, a personnel carrier, a train, a spacecraft, a space station, a submarine, an automobile, a power plant, a bridge, a dam, a house, a manufacturing facility, a building, and other suitable platform for which aerosol detection is desired.

The process begins by emitting a laser beam having a wavelength into an atmosphere (operation 2200). The process receives a backscatter light generated in response to emitting the laser beam into the atmosphere (operation 2202).

The process measures a beat frequency for an interfered light generated from interfering the backscatter light with a reference light derived from the laser beam (operation 2204). The process determines a set of characteristics for the aerosols based on a power of the beat frequency (operation 2206). The process terminates thereafter. In operation 2206, the set of characteristics is selected from at least one of an aerosol concentration, a particle size, or other suitable characteristic.

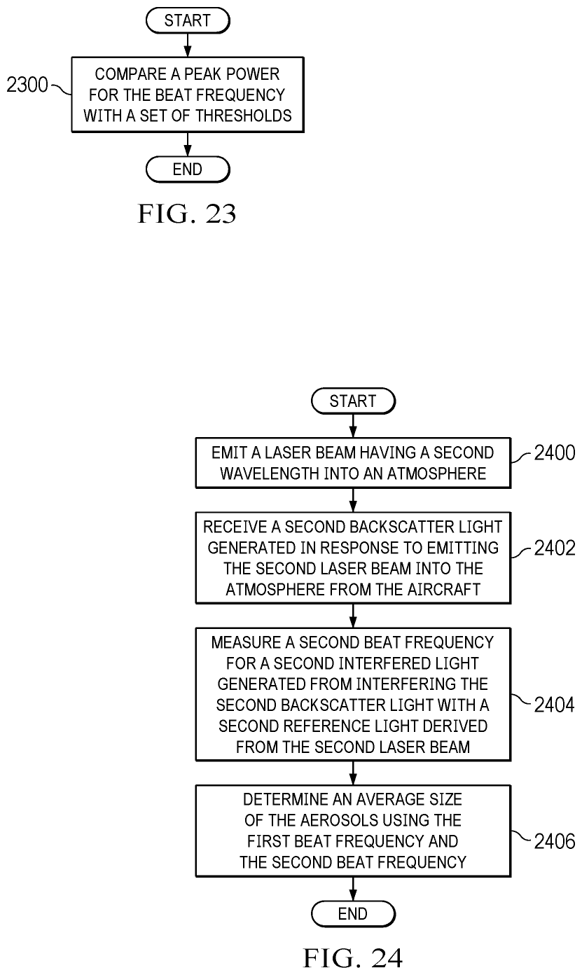

With reference next to FIG. 23, an illustration of a flowchart of a process for determining a characteristic of aerosols is depicted in accordance with an illustrative embodiment. The process in FIG. 23 is an example of an implementation for operation 2206 and FIG. 22.

The process compares a peak power for the beat frequency with a set of thresholds (operation 2300). The process terminates thereafter. In operation 2300, the set of thresholds can be one or more thresholds. In this example, each threshold in the set of thresholds can correspond to a concentration level for the aerosols.

Turning to FIG. 24, an illustration of a flowchart of a process for determining a characteristic of aerosols is depicted in accordance with an illustrative embodiment. The process in FIG. 24 is an example of additional operations that can be used with the operations acted in FIG. 22 and an example implementation for operation example of an implementation for operation 2204 and FIG. 22.

In this example, the laser beam is a first laser beam having a first frequency, the backscatter light is a first backscatter light, the beat frequency is a first beat frequency, and the power is a first power.

The process emits a second laser beam having a second wavelength into the atmosphere (operation 2400). The process receives a second backscatter light generated in response to emitting the second laser beam into the atmosphere from the aircraft (operation 2402).

The process measures a second beat frequency for a second interfered light generated from interfering the second backscatter light with a second reference light derived from the second laser beam (operation 2404).

The process determines an average size of the aerosols using the first beat frequency and the second beat frequency (operation 2406). The process terminates thereafter. In this example, operation 2406 is an example of an implementation for operation 2206 in FIG. 22.

In determining the average size in operation 2406, the backscatter power (P) is proportional to the density of aerosols (φ and a known function (f) of the wavelength (λ), the average diameter (d) of the aerosols:

P=ρ•f(λ,d)

For two measurements on the same volume of atmosphere, the first measurement at a first wavelength λ1 and the second measurement at a second wavelength λ2, two backscatter powers are obtained:

P1=ρ•f(λ1,d)

P2=ρ•f(λ2,d)

The aerosol density and average diameter are the same in both measurements since the measurements are from the same volume of atmosphere. With two equations and two unknowns, “d” and “ρ” can be solved for in this example. Dividing these equations results in the following:

P1/P2=f(λ1,d)/f(λ2,d)

Since the function “f” is nonlinear, this equation can be solved numerically to find “d”. The value of “d” can be used to determine “ρ”.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

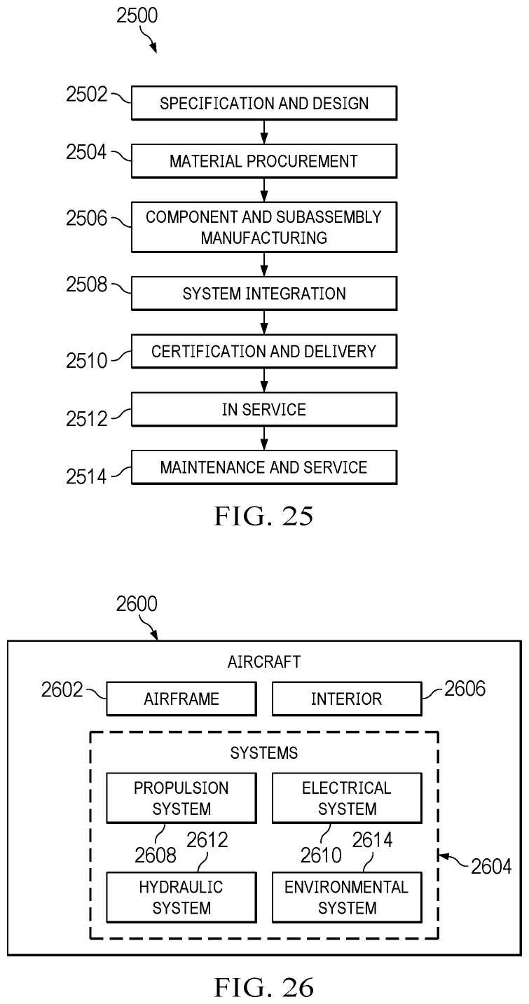

Illustrative embodiments of the disclosure may be described in the context of aircraft manufacturing and service method 2500 as shown in FIG. 25 and aircraft 2600 as shown in FIG. 26. Turning first to FIG. 25, an illustration of an aircraft manufacturing and service method is depicted in accordance with an illustrative embodiment. During pre-production, aircraft manufacturing and service method 2500 may include specification and design 2502 of aircraft 2600 in FIG. 26 and material procurement 2504.

During production, component and subassembly manufacturing 2506 and system integration 2508 of aircraft 2600 in FIG. 26 takes place. Thereafter, aircraft 2600 in FIG. 26 can go through certification and delivery 2510 in order to be placed in service 2512. While in service 2512 by a customer, aircraft 2600 in FIG. 26 is scheduled for routine maintenance and service 2514, which may include modification, reconfiguration, refurbishment, and other maintenance or service.

Each of the processes of aircraft manufacturing and service method 2500 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 26, an illustration of an aircraft is depicted in which an illustrative embodiment may be implemented. In this example, aircraft 2600 is produced by aircraft manufacturing and service method 2500 in FIG. 25 and may include airframe 2602 with plurality of systems 2604 and interior 2606. Examples of systems 2604 include one or more of propulsion system 2608, electrical system 2610, hydraulic system 2612, and environmental system 2614. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 2500 in FIG. 25.

In one illustrative example, components or subassemblies produced in component and subassembly manufacturing 2506 in FIG. 25 can be fabricated or manufactured in a manner similar to components or subassemblies produced while aircraft 2600 is in service 2512 in FIG. 25. As yet another example, one or more apparatus embodiments, method embodiments, or a combination thereof can be utilized during production stages, such as component and subassembly manufacturing 2506 and system integration 2508 in FIG. 25. One or more apparatus embodiments, method embodiments, or a combination thereof may be utilized while aircraft 2600 is in service 2512, during maintenance and service 2514 in FIG. 25, or both. The use of a number of the different illustrative embodiments may substantially expedite the assembly of aircraft 2600, reduce the cost of aircraft 2600, or both expedite the assembly of aircraft 2600 and reduce the cost of aircraft 2600.

For example, a speed detection system in the illustrative examples can be implemented during system integration 2508. This speed detection system can also be added to aircraft 2600 during maintenance and service 2514. This addition can be made during modification, reconfiguration, refurbishment, and other maintenance or service.

Further, the use of the speed detection system can occur during in service 2512 in a manner that provides increased performance in detecting the speed of aircraft 2600 during flight. The accuracy of detecting speed can occur during various conditions for aircraft 2600. For example, the frequency of the laser beam can be selected determine the speed of aircraft 2600 during both normal conditions and abnormal conditions. In abnormal conditions in which a laser beam is emitted through turbulent airflow, the frequency can be selected to reduce dispersion or scattering of the laser beam by the turbulent airflow in one or more illustrative examples.

Some features of the illustrative examples are described in the following clauses. These clauses are examples of features and are not intended to limit other illustrative examples.

Clause 1

A method for detecting a speed of an aircraft, the method comprising:

receiving a first backscatter light generated in response to emitting a first laser beam into an atmosphere from the aircraft, wherein the first laser beam has a first wavelength;

measuring a first beat frequency for a first interfered light generated by interfering the first backscatter light and a first reference light derived from the first laser beam;

receiving a second backscatter light generated in response to emitting a second laser beam into the atmosphere from the aircraft, wherein the second laser beam has a second wavelength;

measuring a second beat frequency for a second interfered light generated by interfering the second backscatter light with a second reference light derived from the second laser beam;

determining the speed of the aircraft using the first beat frequency in response to a first power of the first backscatter light being greater than a threshold; and

determining the speed of the aircraft using the second beat frequency in response to the first power of the first backscatter light not being greater than the threshold.

Clause 2

The method according to clause 1 further comprising:

indicating an error condition in response to a second power of the second backscatter light not being greater than the threshold.

Clause 3

The method according to one of clauses 1 or 2 further comprising:

interfering the first backscatter light with the first reference light to generate the first interfered light having the first beat frequency; and

interfering the second backscatter light with the second reference light to generate the second interfered light having the second beat frequency.

Clause 4

The method according to one of clauses 1, 2, or 3, wherein the first wavelength is selected such that the first power is greater than the threshold in response to an absence of a turbulent airflow in a first path of the first laser beam emitted from the aircraft and wherein the second wavelength is selected such that the first power is greater than the threshold in response to a presence of the turbulent airflow in a second path of the second laser beam emitted from the aircraft.

Clause 5

The method according to one of clauses 1, 2, 3, or 4 further comprising:
measuring the first power of the first backscatter light.

Clause 6

The method according to clause 5, wherein measuring the first power of the first backscatter light comprises:

indirectly measuring the first power of the first backscatter light using the first interfered light generated by interfering the first backscatter light with the first reference light.

Clause 7

The method according to one of clauses 5 or 6, wherein measuring the first power of the first backscatter light comprises:

directly measuring the first power of the first backscatter light using the first backscatter light prior to interfering the first backscatter light with the first reference light.

Clause 8

The method according to one of clauses 1, 2, 3, 4, 5, 6, or 7, wherein the first laser beam having the first wavelength and the second laser beam having the second wavelength are generated by a tunable laser beam generator that generates coherent light for the first laser beam having the first wavelength and the second laser beam having the second wavelength.

Clause 9

The method according to one of clauses 1, 2, 3, 4, 5, 6, 7, or 8, wherein the first laser beam having the first wavelength and the second laser beam having the second wavelength are generated by a first laser unit in a laser beam generator that generates first coherent light for the first laser beam having the first wavelength and a second laser unit in the laser beam generator that generates second coherent light for the second laser beam having the second wavelength.

Clause 10

The method according to one of clauses 1, 2, 3, 4, 5, 6, 7, 8, or 9, wherein the aircraft is selected from one of a commercial aircraft, a commercial airplane, a tilt-rotor aircraft, a tilt wing aircraft, a vertical takeoff and landing aircraft, an electrical vertical takeoff and landing aircraft, a personal air aircraft, a military aircraft, and a fighter jet.

Clause 11

A method for detecting a speed of an aircraft, the method comprising:

emitting a first laser beam having a first wavelength into an atmosphere from the aircraft;

emitting a second laser beam having a second wavelength into the atmosphere from the aircraft;

receiving a first backscatter light generated in response to emitting the first laser beam into the atmosphere from the aircraft;

measuring a first beat frequency for a first interfered light generated from interfering the first backscatter light with a first reference light derived from the first laser beam;

receiving a second backscatter light generated in response to emitting the second laser beam into the atmosphere from the aircraft;

measuring a second beat frequency for a second interfered light generated from interfering the second backscatter light with a second reference light derived from the second laser beam; and

determining the speed of the aircraft using the first beat frequency and the second beat frequency.

Clause 12

The method according to clause 11, wherein the first wavelength is selected such that a first power of the first backscatter light is greater than a threshold in response to an absence of a turbulent airflow in a first path of the first laser beam emitted from the aircraft and wherein the second wavelength is selected such that a second power of the second backscatter light is greater than the threshold in response to a presence of the turbulent airflow in a second path of the second laser beam emitted from the aircraft.

Clause 13

The method according to one of clauses 11 or 12, determining the speed of the aircraft using the first beat frequency and the second beat frequency comprises:

determining the speed of the aircraft using the first beat frequency in response to the first backscatter light having a first power that is greater than a threshold.

Clause 14

The method according to one of clauses 11, 12, or 13, wherein determining the speed of the aircraft using the first beat frequency and the second beat frequency comprises:

determining the speed of the aircraft using the second beat frequency in response to the first backscatter light having a first power that is not greater than a threshold.

Clause 15

The method according to one of clauses 11, 12, 13, or 14, wherein determining the speed of the aircraft using the first beat frequency and the second beat frequency comprises:

determining a first speed using the first beat frequency;

determining a second speed using the second beat frequency; and

determining the speed of the aircraft as an average of the first speed and the second speed.

Clause 16

An aircraft speed detection system for an aircraft, the aircraft speed detection system comprising:

an interference system configured to:

interfere a first backscatter light with a first reference light to form a first interfered light having a first beat frequency in response to receiving the first backscatter light, wherein the first backscatter light is generated in response to emitting a first laser beam having a first wavelength and wherein the first reference light is derived from the first laser beam; and

interfere a second backscatter light with a second reference light to form a second interfered light having a second beat frequency in response to receiving the second backscatter light, wherein the second backscatter light is generated in response to emitting a second laser beam having a second wavelength, the second reference light is derived from the second laser beam, and the first wavelength is shorter than the second wavelength; and

a detection system configured to:

measure the first beat frequency in the first interfered light;

measure the second beat frequency in the second interfered light; and

a speed analyzer configured to:

determine a speed for the aircraft using the first beat frequency in response to a first power of the first backscatter light being greater than a threshold; and

determine the speed for the aircraft using the second beat frequency in response to the first power of the first backscatter light not being greater than the threshold.

Clause 17

The aircraft speed detection system according to clause 16 further comprising:

a laser beam generator configured to selectively emit the first laser beam and the second laser beam into an atmosphere from the aircraft.

Clause 18

The aircraft speed detection system according to clause 17, wherein the speed analyzer is configured to control the laser beam generator to:

emit the first laser beam; and

emit the second laser beam in response to the first backscatter light having the first power that is less than a threshold.

Clause 19

The aircraft speed detection system according to clause 17 further comprising:

a receiver configured to receive the first backscatter light generated in response to emitting the first laser beam and the second backscatter light in response to emitting the second laser beam, wherein the receiver is in communication with the interference system and sends backscatter light received by the receiver to the interference system.

Clause 20

The aircraft speed detection system according to clause 19, wherein the threshold is a selected power for a backscatter light needed to determine the speed of the aircraft.

Clause 21

The aircraft speed detection system according to clause 19, wherein the first wavelength is selected such that the first power is greater than the threshold in response to an absence of a turbulent airflow in a first path of the first laser beam emitted from the aircraft and wherein the second wavelength is selected such that a second power for a second backscatter light is greater than the threshold in response to a presence of the turbulent airflow in a second path of the second laser beam emitted from the aircraft.

Clause 22

The aircraft speed detection system according to one of clauses 17, 18, 19, 20, or 21, wherein the detection system is configured to measure the first power of the first backscatter light.

Clause 23

The aircraft speed detection system according to clause 22, wherein in measuring the first power of the first backscatter light, the detection system is configured to:

indirectly measure the first power of the first backscatter light using the first interfered light generated by interfering the first backscatter light with the first reference light.

Clause 24

The aircraft speed detection system according one of clauses 22 or 23, wherein in measuring the first power of the first backscatter light, the detection system is configured to:

directly measure the first power of the first backscatter light using the first backscatter light prior to interfering the first backscatter light with the first reference light.

Clause 25

An aircraft speed detection system for an aircraft, the aircraft speed detection system comprising:

a laser beam generator configured to emit a first laser beam having a first wavelength and emit a second laser beam having a second wavelength, wherein the first wavelength is shorter than the second wavelength; and

a detection system configured to:

measure a first beat frequency for a first interfered light generated from interfering a first backscatter light detected in response to emitting the first laser beam and a first reference light derived from the first laser beam;

measure a second beat frequency for a second interfered light generated from interfering a second backscatter light detected in response to emitting the second laser beam and a second reference light derived from the second laser beam; and

a speed analyzer configured to determine a speed of the aircraft using the first beat frequency and the second beat frequency.

Clause 26

The aircraft speed detection system according to clause 25 further comprising:

an interference system configured to:

interfere the first backscatter light with the first reference light to form the first interfered light having the first beat frequency in response to receiving the first backscatter light; and

interfere the second backscatter light with the second reference light to form the second interfered light having the second beat frequency in response to receiving the second backscatter light.

Clause 27

The aircraft speed detection system according to one of clauses 25 or 26, wherein the first wavelength is selected such that the a first power of the first backscatter light is greater than a threshold in response to an absence of a turbulent airflow in a first path of the first laser beam emitted from the aircraft and wherein the second wavelength is selected such that a second power of the second backscatter light is greater than the threshold in response to a presence of the turbulent airflow in a second path of the second laser beam emitted from the aircraft.

Clause 28

The aircraft speed detection system according to one of clauses 25, 26, or 27, wherein in determining the speed of the aircraft using the first beat frequency and the second beat frequency, the speed analyzer is configured to:

determine the speed of the aircraft using the first beat frequency in response to the first backscatter light having a first power that is greater than a threshold.

Clause 29

The aircraft speed detection system according to one of clauses 25, 26, 27, or 28, wherein in determining the speed of the aircraft using the first beat frequency and the second beat frequency, the speed analyzer is configured to:

determine the speed of the aircraft using the second beat frequency in response to the first backscatter light having a first power that is not greater than a threshold.

Clause 30

The aircraft speed detection system according to one of clauses 25, 26, 27, 28, or 29, wherein in determining the speed of the aircraft using the first beat frequency and the second beat frequency, the speed analyzer is configured to:

determine a first speed using the first beat frequency;

determine a second speed using the second beat frequency; and

determine the speed of the aircraft as an average of the first speed and the second speed.

Clause 31

An aircraft speed detection system for an aircraft, the aircraft speed detection system comprising:

a first path is configured to:

emit a first laser beam having a first wavelength,

interfere a first backscatter light received in response to emitting the first laser beam with a first reference light derived from the first laser beam to form a first interfered light with a first beat frequency, and

measure the first beat frequency for the first interfered light; and

a second path is configured to:

emit a second laser beam having a second wavelength,

interfere a second backscatter light received in response to emitting the second laser beam with a second reference light derived from the second laser beam to form a second interfered light with a second beat frequency, and

measure the second beat frequency for the first interfered light; and

a speed analyzer in communication with the first path and the second path, wherein the speed analyzer is configured to:

receive the first beat frequency from the first path;

receive the second beat frequency from the second path; and

determine a speed of the aircraft using the first beat frequency and determine the speed of the aircraft using the second beat frequency in response to the first path being out of tolerance.

Clause 32

The aircraft speed detection system according to clause 31, wherein the first path comprises:

a first laser unit configured to emit the first laser beam;

a first interference coupler configured to receive the first backscatter light generated in response to emitting the first laser beam and interferes the first backscatter light with the first reference light to form the first interfered light; and

a first detector connected to the first interference coupler, wherein the first detector is configured to measure the first beat frequency for the first interfered light output by the first interference coupler;

wherein the second path comprises:

a second laser unit configured to emit the second laser beam;

a second interference couple configured to receive the second backscatter light generated in response to emitting the second laser beam and interferes the second backscatter light with the second reference light to form the second interfered light; and

a second detector connected to the second interference coupler, wherein the second detector is configured to measure the second beat frequency for the second interfered light output by the second interference coupler.

Clause 33

The aircraft speed detection system according to one of clauses 31 or 32, wherein the speed analyzer is configured to determine the speed of the aircraft using the first beat frequency in response to the first backscatter light having a power that is greater than a threshold.

Clause 34

The aircraft speed detection system according to one of clauses 31, 32, or 33, wherein the speed analyzer is configured to determine the speed of the aircraft using the second beat frequency in response to the first backscatter light having a power that is not greater than a threshold.

Clause 35

An aircraft speed detection system for an aircraft, the aircraft speed detection system comprising:

a tunable laser beam generator configured to:

selectively emit a first laser beam and a second laser beam into an atmosphere from the aircraft; and

an interference system configured to:

interfere a first backscatter light with a first reference light to form a first interfered light having a first beat frequency in response to receiving the first backscatter light, wherein the first backscatter light is generated in response to emitting the first laser beam having a first wavelength and wherein the first reference light is derived from the first laser beam; and

interfere a second backscatter light with a second reference light to form a second interfered light having a second beat frequency in response to receiving the second backscatter light, wherein the second backscatter light is generated in response to emitting the second laser beam having a second wavelength, the second reference light is derived from the second laser beam, and the first wavelength is shorter than the second wavelength; and

a detection system configured to:

measure the first beat frequency in the first interfered light; and

measure the second beat frequency in the second interfered light; and

a speed analyzer configured to:

determine a speed for the aircraft using the first beat frequency in response to a first power of the first backscatter light being greater than a threshold; and

determine the speed for the aircraft using the second beat frequency in response to the first power of the first backscatter light not being greater than the threshold.

Clause 36

A method for detecting aerosols, the method comprising:

emitting a laser beam into an atmosphere;

receiving a backscatter light generated in response to emitting the laser beam into the atmosphere;

measuring a beat frequency for an interfered light generated from interfering the backscatter light with a reference light derived from the laser beam; and

determining a set of characteristics for the aerosols based on a power of the beat frequency.

Clause 37

The method according to clause 36, wherein the set of characteristics at least one of an aerosol concentration, or a particle size.

Clause 38

The method according to one of clauses 36 or 37, wherein determining the set of characteristics for the aerosols based on a power of the beat frequency comprises:

comparing a peak power for the beat frequency with a set of thresholds, wherein each threshold in the set of thresholds corresponds to a concentration level for the aerosols.

Clause 39

The method according to one of clauses 36, 37, or 38, wherein the laser beam is a first laser beam having a first wavelength, the backscatter light is a first backscatter light, the beat frequency is a first beat frequency, and the power is a first power, and further comprising:

emitting a second laser beam having a second wavelength into the atmosphere;

receiving a second backscatter light generated in response to emitting the second laser beam into the atmosphere from an aircraft;

measuring a second beat frequency for a second interfered light generated from interfering the second backscatter light with a second reference light derived from the second laser beam; and

wherein determining the set of characteristics for the aerosols based on the power of the beat frequency comprises:

determining an average size of the aerosols using the first beat frequency and the second beat frequency.

Clause 40

An aerosol detection system comprising:

a laser generator system configured to emit a laser beam into an atmosphere;

an interference system configured to:

interfere a backscatter light received in response to the laser beam with a reference light derived from the laser beam to form an interfered light having a beat frequency;

a detector configured to:

measuring the beat frequency for the interfered light; and

an aerosol analyzer configured to:

determine a set of characteristics for the aerosols based on a power of the beat frequency.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for detecting a speed of an aircraft, the method comprising:
receiving a first backscatter light generated in response to emitting a first laser beam into an atmosphere from the aircraft, wherein the first laser beam has a first wavelength;
measuring a first beat frequency for a first interfered light generated by interfering the first backscatter light and a first reference light derived from the first laser beam;
receiving a second backscatter light generated in response to emitting a second laser beam into the atmosphere from the aircraft, wherein the second laser beam has a second wavelength;
measuring a second beat frequency for a second interfered light generated by interfering the second backscatter light with a second reference light derived from the second laser beam;
determining the speed of the aircraft using the first beat frequency in response to a first power of the first backscatter light being greater than a threshold; and
determining the speed of the aircraft using the second beat frequency in response to the first power of the first backscatter light not being greater than the threshold.

2. The method of claim 1 further comprising:
indicating an error condition in response to a second power of the second backscatter light not being greater than the threshold.

3. The method of claim 1 further comprising:
interfering the first backscatter light with the first reference light to generate the first interfered light having the first beat frequency; and
interfering the second backscatter light with the second reference light to generate the second interfered light having the second beat frequency.

4. The method of claim 1, wherein the first wavelength is selected such that the first power is greater than the threshold in response to an absence of a turbulent airflow in a first path of the first laser beam emitted from the aircraft and wherein the second wavelength is selected such that the first power is greater than the threshold in response to a presence of the turbulent airflow in a second path of the second laser beam emitted from the aircraft.

5. The method of claim 1 further comprising:
measuring the first power of the first backscatter light.

6. The method of claim 5, wherein measuring the first power of the first backscatter light comprises:
indirectly measuring the first power of the first backscatter light using the first interfered light generated by interfering the first backscatter light with the first reference light.

7. The method of claim 5, wherein measuring the first power of the first backscatter light comprises:
directly measuring the first power of the first backscatter light using the first backscatter light prior to interfering the first backscatter light with the first reference light.

8. The method of claim 1, wherein the first laser beam having the first wavelength and the second laser beam having the second wavelength are generated by a tunable laser beam generator that generates coherent light for the first laser beam having the first wavelength and the second laser beam having the second wavelength.

9. The method of claim 1, wherein the first laser beam having the first wavelength and the second laser beam having the second wavelength are generated by a first laser unit in a laser beam generator that generates first coherent light for the first laser beam having the first wavelength and a second laser unit in the laser beam generator that generates second coherent light for the second laser beam having the second wavelength.

10. The method of claim 1, wherein the aircraft is selected from one of a commercial aircraft, a commercial airplane, a tilt-rotor aircraft, a tilt wing aircraft, a vertical takeoff and landing aircraft, an electrical vertical takeoff and landing aircraft, a personal air aircraft, a military aircraft, and a fighter jet.

11. A method for detecting a speed of an aircraft, the method comprising:
emitting a first laser beam having a first wavelength into an atmosphere from the aircraft;
emitting a second laser beam having a second wavelength into the atmosphere from the aircraft;
receiving a first backscatter light generated in response to emitting the first laser beam into the atmosphere from the aircraft;
measuring a first beat frequency for a first interfered light generated from interfering the first backscatter light with a first reference light derived from the first laser beam;
receiving a second backscatter light generated in response to emitting the second laser beam into the atmosphere from the aircraft;
measuring a second beat frequency for a second interfered light generated from interfering the second backscatter light with a second reference light derived from the second laser beam; and
determining the speed of the aircraft using the first beat frequency and the second beat frequency.

12. The method of claim 11, wherein the first wavelength is selected such that a first power of the first backscatter light is greater than a threshold in response to an absence of a turbulent airflow in a first path of the first laser beam emitted from the aircraft and wherein the second wavelength is selected such that a second power of the second backscatter light is greater than the threshold in response to a presence of the turbulent airflow in a second path of the second laser beam emitted from the aircraft.

13. The method of claim 11, determining the speed of the aircraft using the first beat frequency and the second beat frequency comprises:
determining the speed of the aircraft using the first beat frequency in response to the first backscatter light having a first power that is greater than a threshold.

14. The method of claim 11, wherein determining the speed of the aircraft using the first beat frequency and the second beat frequency comprises:
determining the speed of the aircraft using the second beat frequency in response to the first backscatter light having a first power that is not greater than a threshold.

15. The method of claim 11, wherein determining the speed of the aircraft using the first beat frequency and the second beat frequency comprises:
determining a first speed using the first beat frequency;
determining a second speed using the second beat frequency; and
determining the speed of the aircraft as an average of the first speed and the second speed.

16. An aircraft speed detection system for an aircraft, the aircraft speed detection system comprising:
an interference system configured to:
interfere a first backscatter light with a first reference light to form a first interfered light having a first beat frequency in response to receiving the first backscatter light, wherein the first backscatter light is generated in response to emitting a first laser beam having a first wavelength and wherein the first reference light is derived from the first laser beam; and
interfere a second backscatter light with a second reference light to form a second interfered light having a second beat frequency in response to receiving the second backscatter light, wherein the second backscatter light is generated in response to emitting a second laser beam having a second wavelength, the second reference light is derived from the second laser beam, and the first wavelength is shorter than the second wavelength; and
a detection system configured to:
measure the first beat frequency in the first interfered light;
measure the second beat frequency in the second interfered light; and
a speed analyzer configured to:
determine a speed for the aircraft using the first beat frequency in response to a first power of the first backscatter light being greater than a threshold; and
determine the speed for the aircraft using the second beat frequency in response to the first power of the first backscatter light not being greater than the threshold.

17. The aircraft speed detection system of claim 16 further comprising:
a laser beam generator configured to selectively emit the first laser beam and the second laser beam into an atmosphere from the aircraft.

18. The aircraft speed detection system of claim 17, wherein the speed analyzer is configured to control the laser beam generator to:
emit the first laser beam; and
emit the second laser beam in response to the first backscatter light having the first power that is less than a threshold.

19. The aircraft speed detection system of claim 17 further comprising:
a receiver configured to receive the first backscatter light generated in response to emitting the first laser beam and the second backscatter light in response to emitting the second laser beam, wherein the receiver is in communication with the interference system and sends backscatter light received by the receiver to the interference system.

20. The aircraft speed detection system of claim 19, wherein the threshold is a selected power for a backscatter light needed to determine the speed of the aircraft.

21. The aircraft speed detection system of claim 19, wherein the first wavelength is selected such that the first power is greater than the threshold in response to an absence of a turbulent airflow in a first path of the first laser beam emitted from the aircraft and wherein the second wavelength is selected such that a second power for a second backscatter light is greater than the threshold in response to a presence of the turbulent airflow in a second path of the second laser beam emitted from the aircraft.

22. The aircraft speed detection system of claim 17, wherein the detection system is configured to measure the first power of the first backscatter light.

23. The aircraft speed detection system of claim 22, wherein in measuring the first power of the first backscatter light, the detection system is configured to:
indirectly measure the first power of the first backscatter light using the first interfered light generated by interfering the first backscatter light with the first reference light.

24. The aircraft speed detection system of claim 22, wherein in measuring the first power of the first backscatter light, the detection system is configured to:
directly measure the first power of the first backscatter light using the first backscatter light prior to interfering the first backscatter light with the first reference light.

25. An aircraft speed detection system for an aircraft, the aircraft speed detection system comprising:
a laser beam generator configured to emit a first laser beam having a first wavelength and emit a second laser beam having a second wavelength, wherein the first wavelength is shorter than the second wavelength; and
a detection system configured to:
measure a first beat frequency for a first interfered light generated from interfering a first backscatter light detected in response to emitting the first laser beam and a first reference light derived from the first laser beam;
measure a second beat frequency for a second interfered light generated from interfering a second backscatter light detected in response to emitting the second laser beam and a second reference light derived from the second laser beam; and
a speed analyzer configured to determine a speed of the aircraft using the first beat frequency and the second beat frequency.

26. The aircraft speed detection system of claim 25 further comprising:
an interference system configured to:
interfere the first backscatter light with the first reference light to form the first interfered light having the first beat frequency in response to receiving the first backscatter light; and
interfere the second backscatter light with the second reference light to form the second interfered light having the second beat frequency in response to receiving the second backscatter light.

27. The aircraft speed detection system of claim 25, wherein the first wavelength is selected such that the a first power of the first backscatter light is greater than a threshold in response to an absence of a turbulent airflow in a first path of the first laser beam emitted from the aircraft and wherein the second wavelength is selected such that a second power of the second backscatter light is greater than the threshold in response to a presence of the turbulent airflow in a second path of the second laser beam emitted from the aircraft.

28. The aircraft speed detection system of claim 25, wherein in determining the speed of the aircraft using the first beat frequency and the second beat frequency, the speed analyzer is configured to:
determine the speed of the aircraft using the first beat frequency in response to the first backscatter light having a first power that is greater than a threshold.

29. The aircraft speed detection system of claim 25, wherein in determining the speed of the aircraft using the first beat frequency and the second beat frequency, the speed analyzer is configured to:
determine the speed of the aircraft using the second beat frequency in response to the first backscatter light having a first power that is not greater than a threshold.

30. The aircraft speed detection system of claim 25, wherein in determining the speed of the aircraft using the first beat frequency and the second beat frequency, the speed analyzer is configured to:
determine a first speed using the first beat frequency;
determine a second speed using the second beat frequency; and
determine the speed of the aircraft as an average of the first speed and the second speed.

31. An aircraft speed detection system for an aircraft, the aircraft speed detection system comprising:
a first path is configured to:
emit a first laser beam having a first wavelength, interfere a first backscatter light received in response to emitting the first laser beam with a first reference light derived from the first laser beam to form a first interfered light with a first beat frequency, and measure the first beat frequency for the first interfered light; and
a second path is configured to:
emit a second laser beam having a second wavelength, interfere a second backscatter light received in response to emitting the second laser beam with a second reference light derived from the second laser beam to form a second interfered light with a second beat frequency, and measure the second beat frequency for the first interfered light; and
a speed analyzer in communication with the first path and the second path, wherein the speed analyzer is configured to:
receive the first beat frequency from the first path;
receive the second beat frequency from the second path; and
determine a speed of the aircraft using the first beat frequency and determine the speed of the aircraft using the second beat frequency in response to the first path being out of tolerance.

32. The aircraft speed detection system of claim 31, wherein the first path comprises:
a first laser unit configured to emit the first laser beam;
a first interference coupler configured to receive the first backscatter light generated in response to emitting the first laser beam and interferes the first backscatter light with the first reference light to form the first interfered light; and
a first detector connected to the first interference coupler, wherein the first detector is configured to measure the first beat frequency for the first interfered light output by the first interference coupler;
wherein the second path comprises:
a second laser unit configured to emit the second laser beam;
a second interference coupler configured to receive the second backscatter light generated in response to emitting the second laser beam and interferes the second backscatter light with the second reference light to form the second interfered light; and
a second detector connected to the second interference coupler, wherein the second detector is configured to measure the second beat frequency for the second interfered light output by the second interference coupler.

33. The aircraft speed detection system of claim 31, wherein the speed analyzer is configured to determine the speed of the aircraft using the first beat frequency in response to the first backscatter light having a power that is greater than a threshold.

34. The aircraft speed detection system of claim 31, wherein the speed analyzer is configured to determine the speed of the aircraft using the second beat frequency in response to the first backscatter light having a power that is not greater than a threshold.

35. An aircraft speed detection system for an aircraft, the aircraft speed detection system comprising:
a tunable laser beam generator configured to:
selectively emit a first laser beam and a second laser beam into an atmosphere from the aircraft; and
an interference system configured to:
interfere a first backscatter light with a first reference light to form a first interfered light having a first beat frequency in response to receiving the first backscatter light, wherein the first backscatter light is generated in response to emitting the first laser beam having a first wavelength and wherein the first reference light is derived from the first laser beam; and
interfere a second backscatter light with a second reference light to form a second interfered light having a second beat frequency in response to receiving the second backscatter light, wherein the second backscatter light is generated in response to emitting the second laser beam having a second wavelength, the second reference light is derived from the second laser beam, and the first wavelength is shorter than the second wavelength; and
a detection system configured to:
measure the first beat frequency in the first interfered light; and
measure the second beat frequency in the second interfered light; and
a speed analyzer configured to:
determine a speed for the aircraft using the first beat frequency in response to a first power of the first backscatter light being greater than a threshold; and
determine the speed for the aircraft using the second beat frequency in response to the first power of the first backscatter light not being greater than the threshold.

36. A method for detecting aerosols, the method comprising:
emitting a laser beam into an atmosphere;
receiving a backscatter light generated in response to emitting the laser beam into the atmosphere;
measuring a beat frequency for an interfered light generated from interfering the backscatter light with a reference light derived from the laser beam; and
determining a set of characteristics for the aerosols based on a power of the beat frequency.

37. The method of claim 36, wherein the set of characteristics at least one of an aerosol concentration, or a particle size.

38. The method of claim 36, wherein determining the set of characteristics for the aerosols based on a power of the beat frequency comprises:
comparing a peak power for the beat frequency with a set of thresholds, wherein each threshold in the set of thresholds corresponds to a concentration level for the aerosols.

39. The method of claim 36, wherein the laser beam is a first laser beam having a first wavelength, the backscatter light is a first backscatter light, the beat frequency is a first beat frequency, and the power is a first power, and further comprising:
emitting a second laser beam having a second wavelength into the atmosphere;
receiving a second backscatter light generated in response to emitting the second laser beam into the atmosphere from an aircraft;
measuring a second beat frequency for a second interfered light generated from interfering the second backscatter light with a second reference light derived from the second laser beam; and
wherein determining the set of characteristics for the aerosols based on the power of the beat frequency comprises:
determining an average size of the aerosols using the first beat frequency and the second beat frequency.

40. An aerosol detection system comprising:
a laser generator system configured to emit a laser beam into an atmosphere;
an interference system configured to:
interfere a backscatter light received in response to the laser beam with a reference light derived from the laser beam to form an interfered light having a beat frequency;
a detector configured to:
measuring the beat frequency for the interfered light; and
an aerosol analyzer configured to:
determine a set of characteristics for the aerosols based on a power of the beat frequency.
